(19) United States
(12) Patent Application Publication
(10) Pub. No.: US 2002/0143862 A1
(43) Pub. Date: Oct. 3, 2002

(54) Method and apparatus for transferring information between a source and a destination on a network

(75) Inventor: Diane L. Peterson, Temple, TX (US)

Correspondence Address: HOWISON, THOMA & ARNOTT, L.L.P, P.O. BOX 741715, DALLAS, TX, 75374-1715, US

(73) Assignee: Atitania Ltd.

(21) Appl. No.: 09/860,418

(22) Filed: May 18, 2001

Related U.S. Application Data
(60) Provisional application No. 60/206,013, filed on May 19, 2000.

(51) Int. Cl. G06F 15/16

(52) U.S. Cl. 709/203; 709/237

(57) ABSTRACT

Method and apparatus for transferring information between a source and a destination on a network. This process includes the step of reading a unique ID, which unique ID is associated with a plurality of information destinations on a network. At least two other external items of information are received in conjunction with the step of reading the unique ID, wherein the unique ID is associated with corresponding items of information that may be identical or similar to the received at least two other external items of information which corresponding items of information are disposed at predetermined destinations on the network. A relational database is provided having stored therein the relationship between the unique ID and the plurality of associated destinations on the network. The read unique ID is processed in response to the step of reading to determine the destination on the network for the corresponding information to the received at least two other external items of information. Each of the destinations is interfaced with and a predetermined process performed utilizing each of the received at least two other external information items with the associated destination in an independent and separate operation in accordance with the predetermined goal.

### CROSS-REFERENCE TO RELATED APPLICATIONS

This application claims priority in U.S. Provisional Application No. 60/206,013, filed May 19, 2000 (Atty. Dkt. No. ATTA-25,122) entitled “COMMERCE STRUCTURE”.

### TECHNICAL FIELD OF THE INVENTION

This invention is related to the field of a commerce structure, commerce architecture, commerce protocol, and commerce processes, and more particularly, it deals with the presentation, routing, networking, data storage, data hierarchy, and processes for all of commerce.

### BACKGROUND OF THE INVENTION

There is no real-time processing and routing of information. Some companies use Electronic Data Interchange (EDI), and others do not use the EDI process. It is quite costly to do the EDI process. There are full departments that program the EDI process. Each company does their own processing. The EDI process is not in real time. Each company sets up their own process. They do not look at the data flow. Each company has a different process. They may have a release process or may not have a release process. There is no auto-configurable process. There is no uniform process for data being taken in. The palm pilot has its own interface, while the e-commerce has another interface. There is no unique keying structure like the IP address. There is no meaningful key. The key can be used to link two systems together. The GUI has no structure like the phone book.

The dot corns have their own structure to each of their pages. The company buy.com is creating multiple dots to handle different buying sites. The front page uses multiple links to link to information. The transmission process is not able to use multiple passing to information. The information can not be rerouted in real-time. A programmer has to reroute the information. There is no process can reconfigure in real-time. A programmer has to set up the re-configuration. There are no workflow controls. Each company sets up its own configuration. They are not always happy with their configuration or their process. Companies can not create their own workflow. Each company is recreating their own classification. An item may have the car number process. If the industries do not standardize, an industry can have multiple classifications like the medical industries. The data can not be consolidated to any form. The document structure does not allow for this process. A programmer has to consolidate the data. There is no security with most of the system's transactions. People have published credit card numbers on the internet. There is no way that the existing process allows for new processes to be created. There is no process to pre-allocate your travel or college expenses. The Global World is being ignored. The classification helps the world commerce become more global. The technical world does not take time to analyze the process. They are more in a reaction mode. Standards are the last thing on their mind. This invention brings standards to the commerce world.

### SUMMARY OF THE INVENTION

The present invention disclosed and claimed herein, in one aspect thereof, comprises a commerce process. This process includes the step of reading a unique ID, which unique ID is associated with a plurality of information destinations on a network. At least two other external items of information are received in conjunction with the step of reading the unique ID, wherein the unique ID is associated with corresponding items of information that may be identical or similar to the received at least two other external items of information which corresponding items of information are disposed at predetermined destinations on the network. A relational database is provided having stored therein the relationship between the unique ID and the plurality of associated destinations on the network. The read unique ID is processed in response to the step of reading to determine the destination on the network for the corresponding information to the received at least two other external items of information. Each of the destinations is interfaced with and a predetermined process performed utilizing each of the received at least two other external information items with the associated destination in an independent and separate operation in accordance with the predetermined goal.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a flowchart of the prior art EDI data flow, which uses overnight or period batch processing;

FIGS. 2a, 2b, and 2d illustrate block diagrams of a source system, receives data and fulfills the orders;

FIGS. 2c and 2e illustrate the components of the data warehouse in more detail;

FIGS. 3a and 3b illustrate a host data channel server connected to a client data channel server to send transactions in real-time;

FIGS. 3c and 3d illustrate a host data channel server connected to a client data channel server to send transactions in real-time;

FIGS. 3e and 3f illustrate a host data channel server connected to a client data channel server to send transactions in real-time;

FIGS. 3g and 3h illustrate a host data channel server connected to a client data channel server to send transactions in real-time;

FIGS. 3i and 3j illustrate a host data channel server connected to a client data channel server to send transactions in real-time

FIGS. 3k and 3l illustrate a host data channel server connected to a client data channel server to send transactions in real-time;

FIGS. 3m and 3n illustrate a host data channel server connected to a client data channel server to send transactions in real-time;

FIGS. 3o and 3p illustrate a host data channel server connected to a client data channel server to send transactions in real-time;

FIGS. 3q and 3r illustrate a host data channel server connected to a client data channel server to send transactions in real-time;

FIG. 3s illustrates the redirection division;

FIG. 3t illustrates the machine division;

FIG. 3u illustrates the channel division;

FIG. 3v illustrates the data division;

FIG. 3w illustrates the reroute division;

FIG. 3x illustrates the route division;

FIG. 3y illustrates the application division;

FIG. 4 illustrates the data structure of prior art EDI ordering systems;

FIGS. 5 and 6 illustrate the data structures for processing in the present system;

FIG. 7 illustrates the data flow from input to output;

FIG. 8 illustrates how information is forward;

FIG. 9a illustrates the transaction hierarchy;

FIG. 9b illustrates the account hierarchy;

FIG. 9c illustrates the item hierarchy;

FIG. 9d illustrates the directory hierarchy;

FIG. 9e illustrates the business hierarchy;

FIG. 9f illustrates the document hierarchy;

FIG. 9g illustrates part of the search hierarchy;

FIG. 10 illustrates the WPCP;

FIGS. 11a-e illustrate the directory structure;

FIG. 12 illustrates the number conversion;

FIG. 13 illustrates the translation; and

FIGS. 14a-c illustrate the alpha and omega points of origin

FIG. 15 illustrates a block diagram of an example of a commerce process;

FIG. 16 illustrates a diagram of a relational database structure stored locally to the process of FIG. 15; and

FIG. 17 illustrates a flow chart for the commerce process.

### DETAILED DESCRIPTION OF THE INVENTION

There are five major parts to the invention: the Commerce Structure, the Commerce Architecture, the Commerce Protocol, the Commerce Sources, the Commerce Messages, the Commerce Processes, the Commerce Products, and the Commerce Open Systems. The Commerce Structure is the data process. The Commerce Architecture is the foundation. The Commerce Protocol is the language. The Commerce Messages are the messages that are transferred. The Commerce Source is the permanent source IDs. The Commerce Process is the way the information flows. The Commerce Product is a new product for the new process. The Open System allows for modifications.

Commerce Structure

The Commerce Structure has the data flow process, the transmission process, the transaction process, and the information process.

Data Flow Process

The first problem is the flow of the data from the source system to the destination system. There is no uniform method. The business writes and rewrites their data links for their business entity. Each business has its own way the data must flow.

Channel

Perfect Data Flow

The process today is not uniform. Each company has its own method of connecting and transporting information. Some have a released process and some send information directly in and out. There are numerous ways.

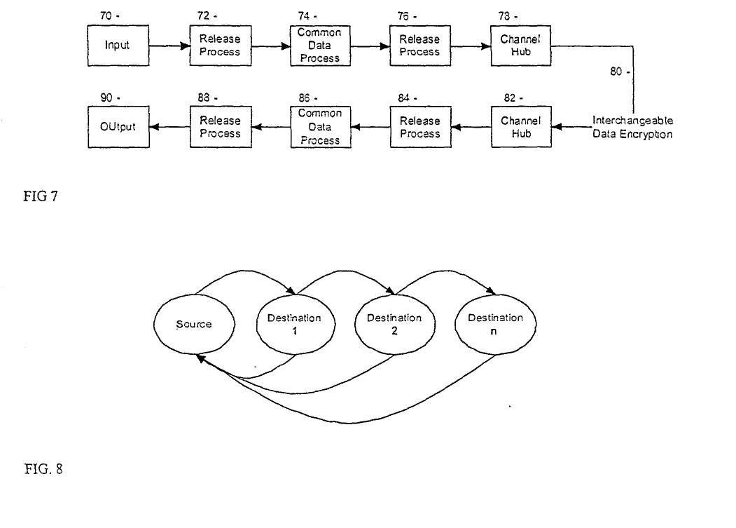

The process can be uniformed. FIG. 7 shows this uniformed process. The input 70 is the source systems. The release process 72 has a time release or quantitative release when the data is being pulled out into the common data area process 74. This release process 72 can insert data in full refreshes or incremental refreshes. It can be done in a batch mode or a real-time mode. This release process 72 eliminates the stress of the input systems 70. The data can be held in the common data area to be changed by individual, to be approved by an individual; or to be inserted in an individual's file, table or spreadsheet. The release process 76 controls the flow into the data in the channel hub 78. The data can be held so that the system does not over flow the channel. The channel hub 78 encrypts the data 80; sends the data to channel hub 82. The channel hub unencrypts the data. The release process 84 can control the data into common data area 86. A user could be working on the data and the new data needs to be held not to overwrite the old data. The data flow may not be a good time to release the data when a user is working in that area. The common data area 86 may need to be held for data approval before being released. The data can be held for a time released process 88. This release allows the data flow not to over flow the output system. The output 90 is the destination system. Both source and destination systems write a transaction record to its data warehouse. The system can work with just the input 70, the channel Hub 78, and the output 90. The system can just have an input system itself. This is a recursive process where the input becomes the output. The disclosed architecture can have another step added to the data flow with no problem. This is a re-configurable system. This disclosed architecture could be reconfigured with no adaptation time. This process can be configured to meet the clients needs. Any records that are rejected by the system will notify the input and output systems with a reason and who rejected. An entry screen can be placed anywhere along the data flow to enter in the data. The data can be limited to the data flow on the system since the device, the user, the transaction type and other information are stored in the router table. The input or the release process can handle conversions and the output or the release process can handle the conversions. The data flow has different points. The system will allow new points to be added and will allow existing points to be removed. This is a configurable system.

Data Flow Failure

Each side is notified that an error occurred. The system records in which section the error occurred. The user can just check for a retransmission. They can correct it and then check the retransmission. The user can just reenter the information and tie the information to the error message. The user can cancel the error message and note why the user cancelled it.

Data Warehouse

The Active Data Warehouse contains only the active records. This allows for fast retrieval of records. The Storage Data Warehouse has all the records. This allows for all calculations to be performed. Some applications have only one warehouse and not two.

Transaction Process

A second problem with conventional systems is the transaction process. There is no source and destination in systems. This problem makes it difficult to track information. The information must have a transaction number, transaction line number, transaction date, source, destination and other information. The source and destination can be placed in airline devices, ERP systems, HR systems, other information systems, any devices, and anything that needs tracking. The source and destination allow for information to be rerouted. If the destination is not where the information needs to be, the system can be rerouted. The source and destination remains the same, while the forward destination is stored in forward CP key. The source is notified that the information was rerouted. The source will have a message why it is forwarded. The information FIG. 8 can be forwarded numerous times. The information can be forwarded to itself.

The source and destination allow for information to be a reply. The reply can be sent to the following:

To all destinations

To all sources

To all sources and destinations

To all destinations for a given date

To all sources for a given date

To all destinations and sources for a given date

To all sources for any given criteria

To all destinations for any criteria

To all destinations and sources for any criteria.

The source key can be placed in the initialization of an installation of a product. This is a wrapper. If there is no source, the information is not sent.

Transmission Process

A third problem is the way the data is processed.

Data Movement

These data processing problems exist not only for the direct retail orders, but they also exist in the business to business purchasing. Companies using the conventional electronic methods of purchasing and selling (i.e. EDI) have not been able to use the new and growing methods of electronic commerce used on the Internet. There are a number of reasons that business-to-business transactions are not currently being done on the Internet or through the web. One major reason is that companies have invested in EDI and the infrastructure needed to use those protocols. This method of doing electronic business has become entrenched over the last 20-30 years.

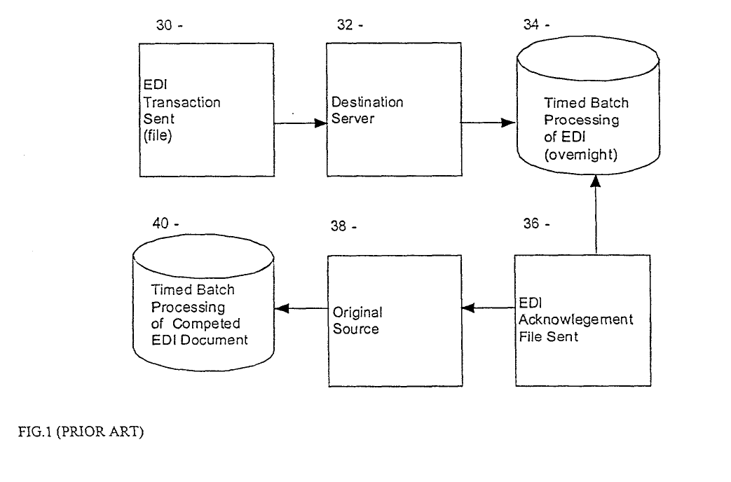

Although EDI has attained widespread use, there are some significant drawbacks to using EDI. FIG. 1 shows the typical flow of information in an EDI System. In EDI, documents 30 are sent from a source. These documents may be purchase orders, bills of lading, order placement and processing, shipping and receiving, invoicing, and payment. The document being sent is then stored on the destination server 32 for a period of time. This document must then be converted by a piece of software known as an EDI translator and finally processed as a transaction. This processing usually takes place in a timed batch processing event 34. A major drawback to batch processing is that it must usually be performed overnight because of the processing load, which is required. This included the additional overhead involved in translating the EDI documents. After the EDI document request has been processed by the destination system, an acknowledgment EDI file 36 is sent back to the original source server 38. The acknowledgment document will be batch processed 40 after it has been received. This system produces a lot of overhead and time delay. Of course, the system could just run the batch processing more frequently in order to speed up the system. This is generally not possible in a large volume system because of the overhead associated with the translation and processing.

Drawing 3a and 3b

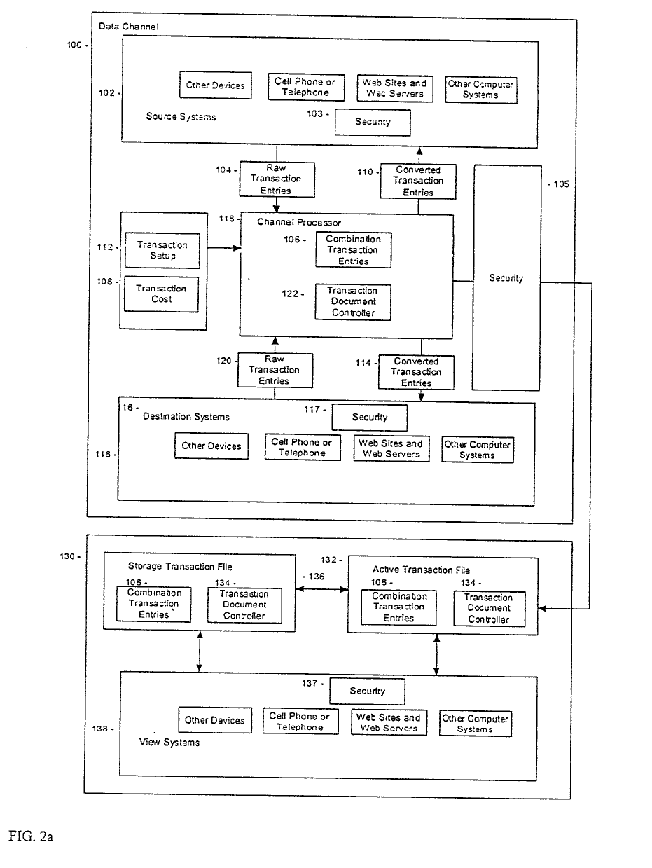

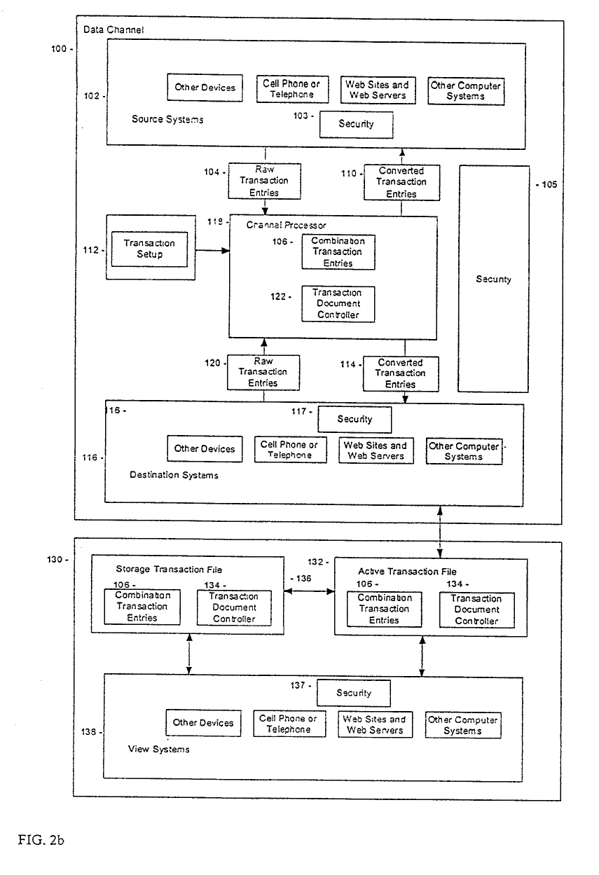

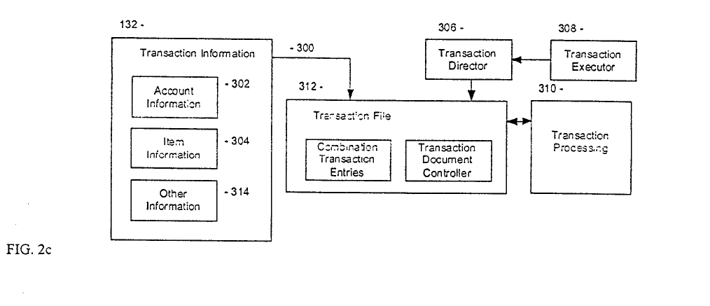

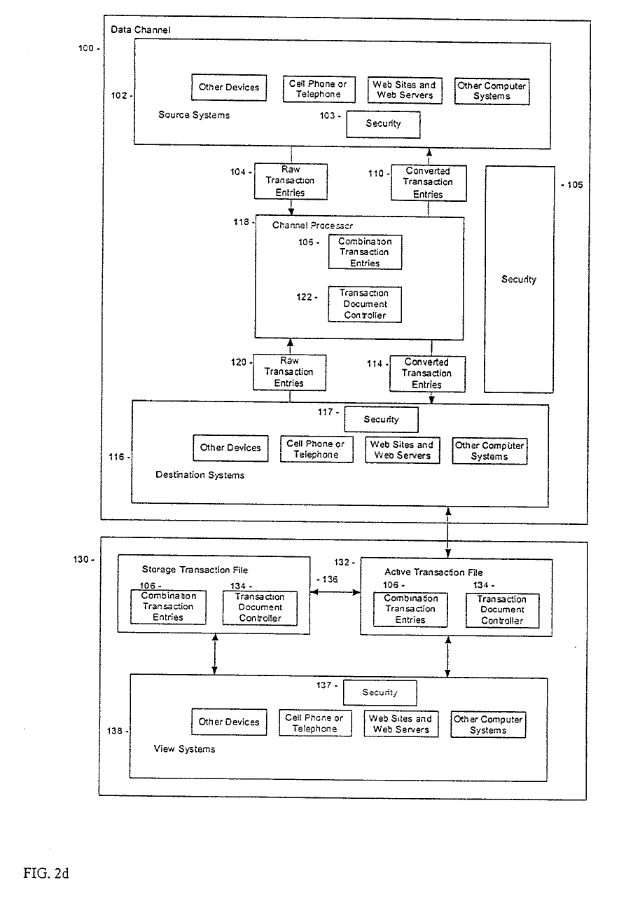

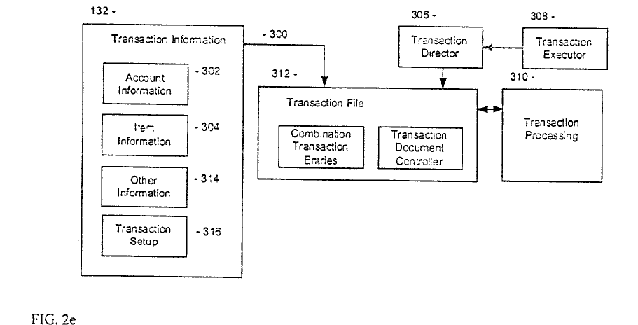

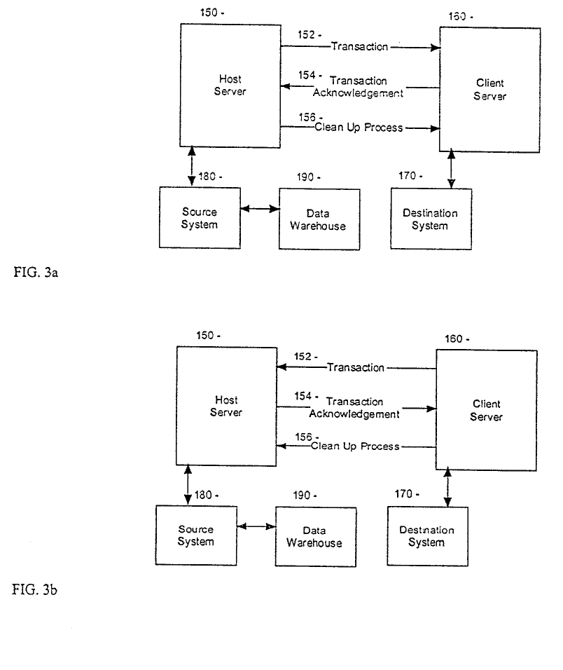

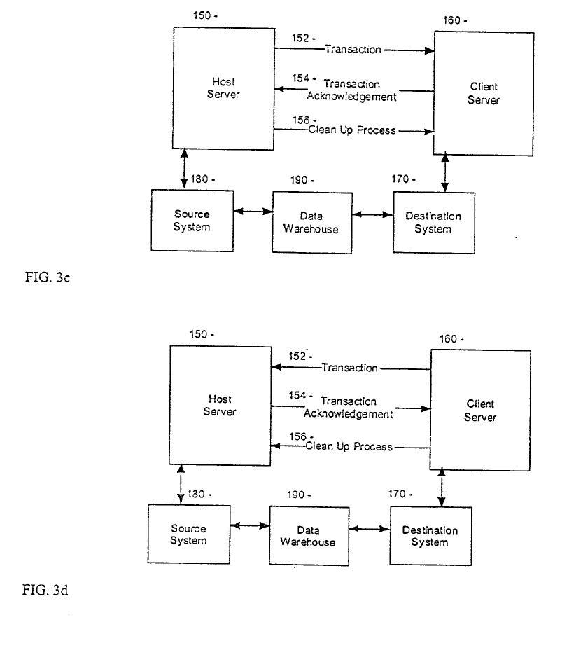

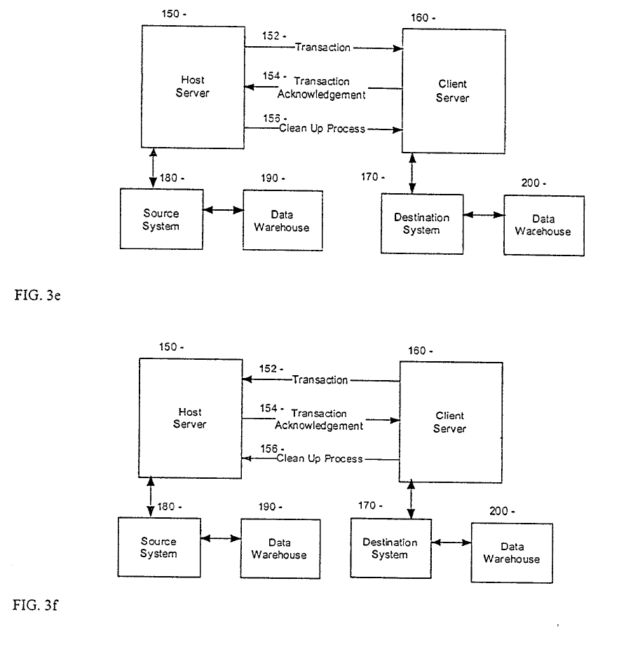

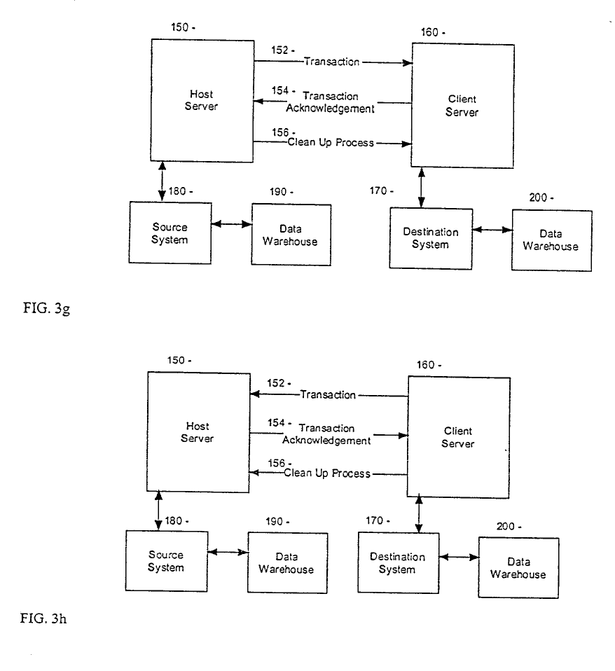

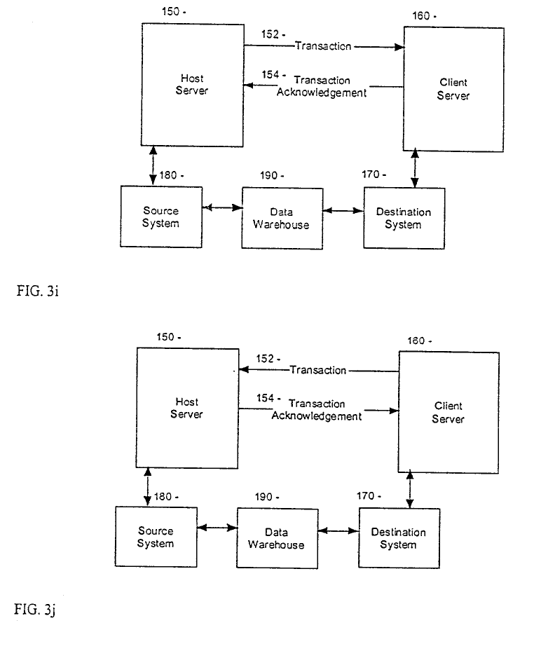

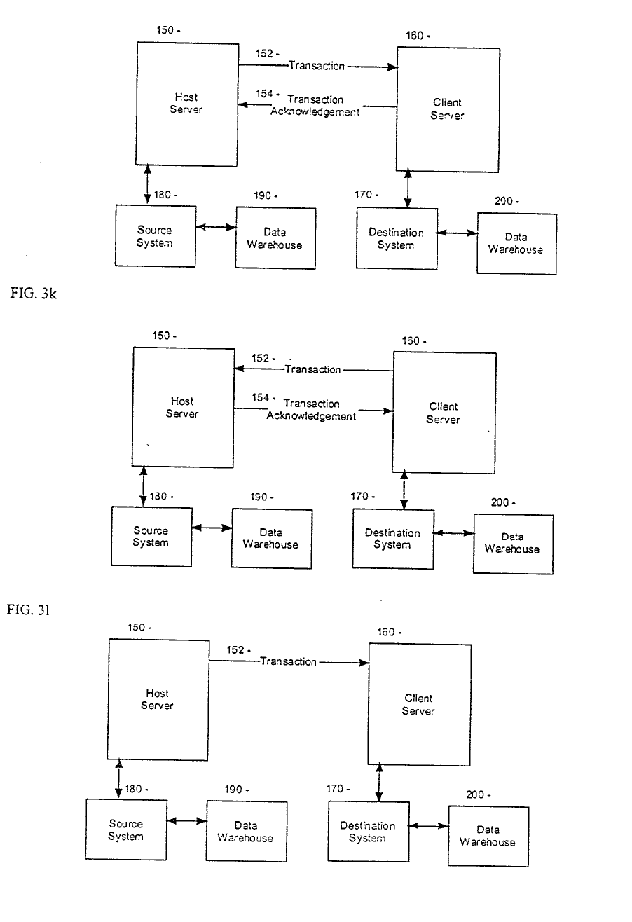

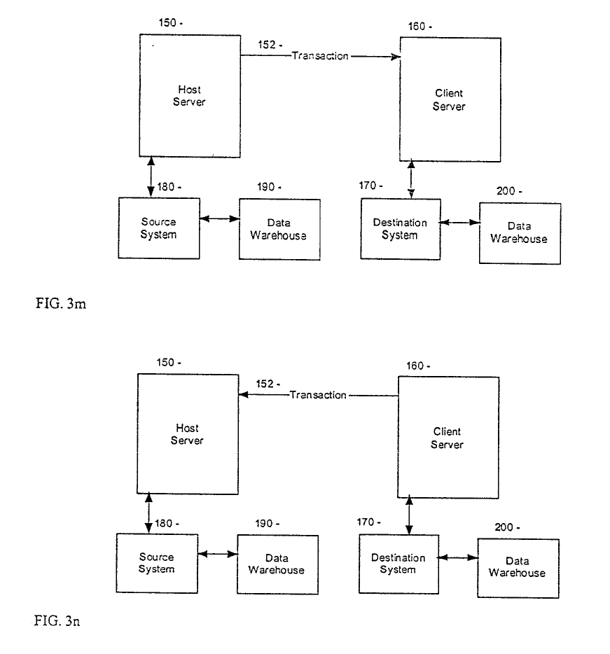

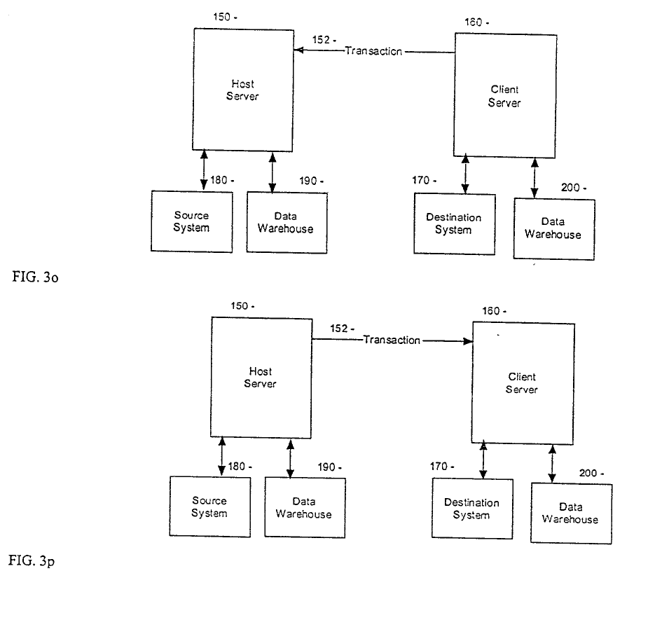

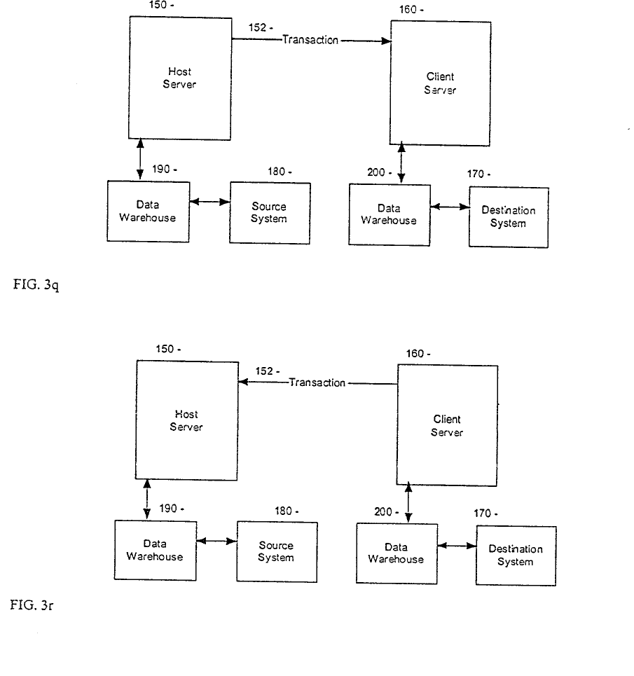

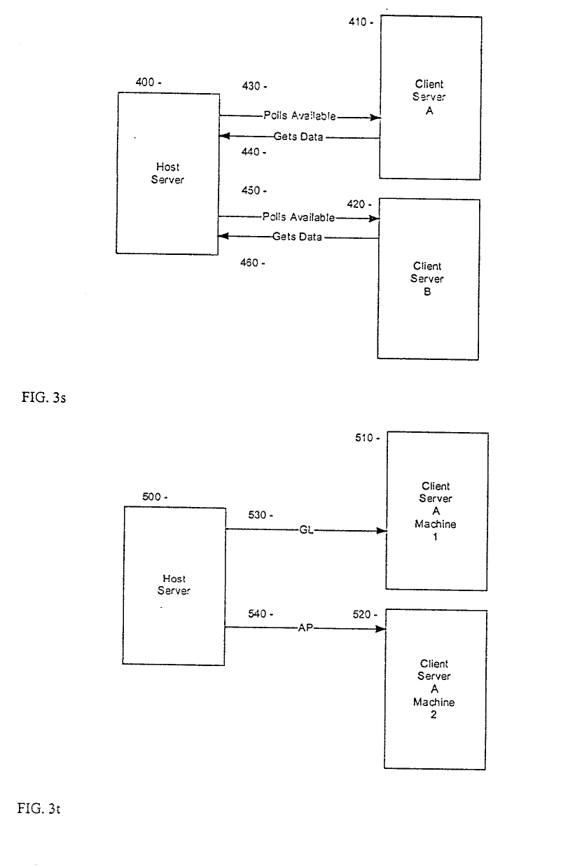

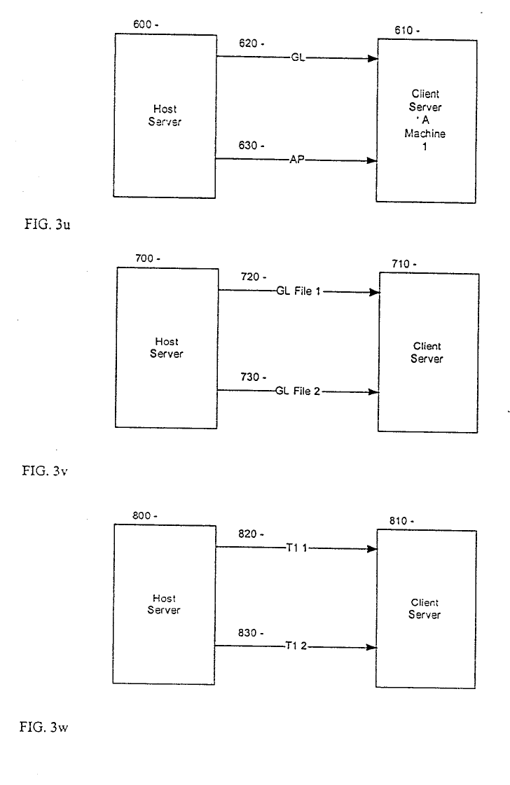

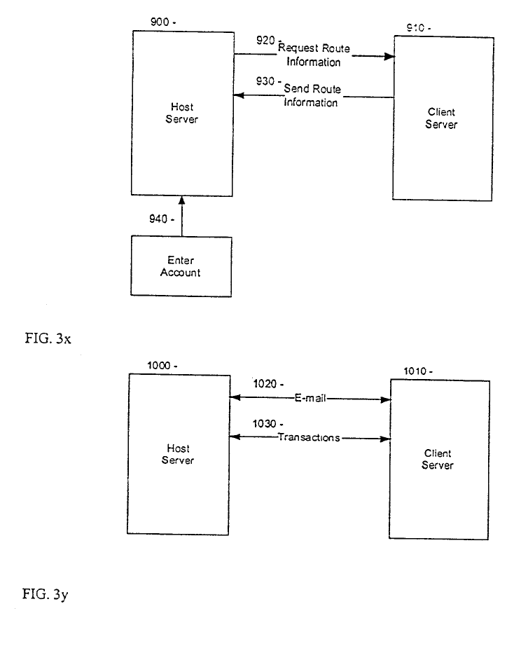

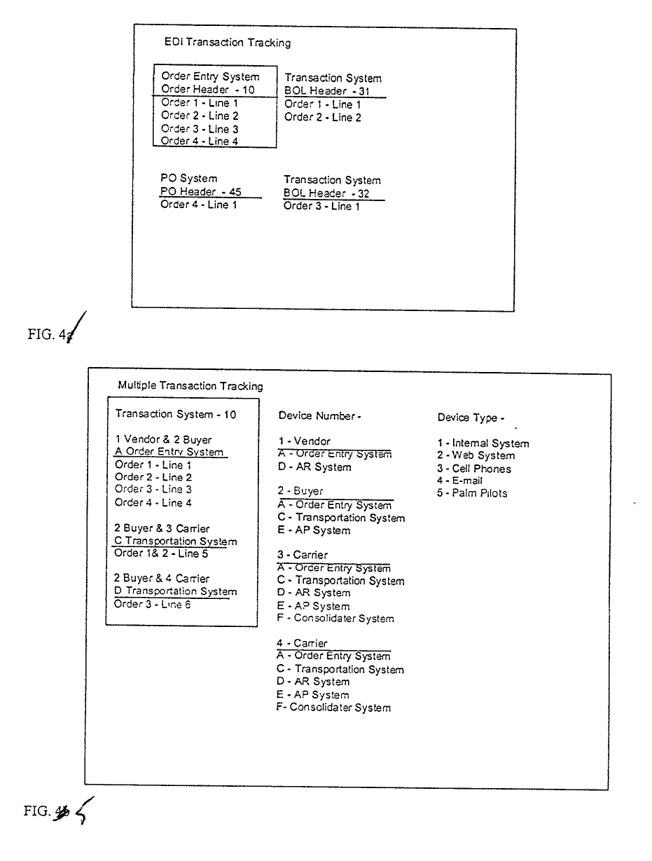

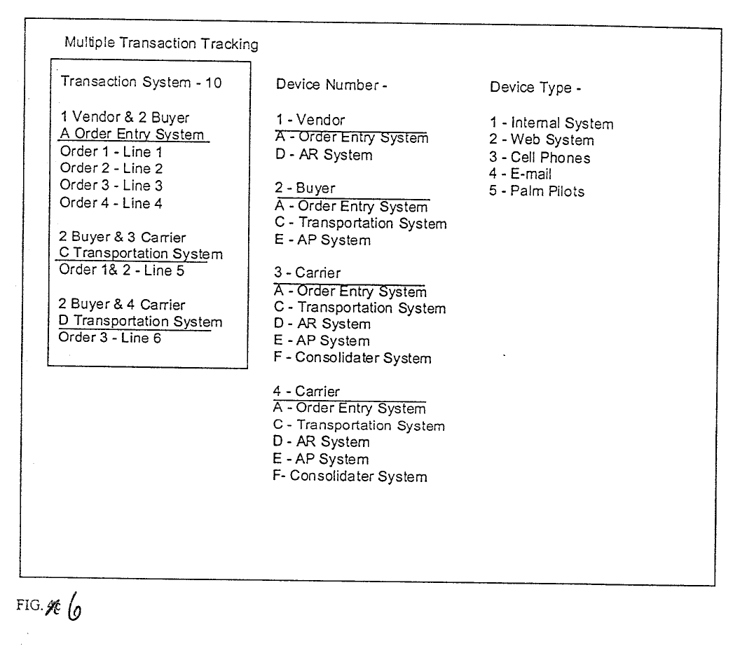

Referring now to FIG. 3a, the interaction between the host channel server and the channel software on the client is outlined. After the host channel server 150 has received a transaction and converted it into a combination transaction entry, that transaction is sent to the client channel server 152. It should be mentioned that the client channel software may reside on a separate client channel server 160 or the software may be contained within the destination system 170. Having the client channel software reside on a separate server allows for scalability. The client software residing on one server can service many destination servers to conserve computing resources. The transaction is passed on to a destination system 170 for accounting or shipping as needed. The client channel server 160 then returns a transaction acknowledgment 154 after the transaction is processed in real time. After the acknowledgment has been returned to the host channel server 150, the host channel server instructs the client channel to the clean up process 156. This way the transaction is deleted from the client channel server 160 to free up the channel resources. The transaction is then transferred from the host channel server to the data warehouse 190 as described in FIG. 2a. If the data cannot be transferred than error code is returned.

FIG. 2b shows a similar data flow when a transaction is sent from the client channel server 160 to the channel server 150. These transactions would include messages that the transportation of the goods is complete or accounting messages. This interaction is important because it is a real-time response and does not have to wait for batch processing. The host channel 150 will also delete the transaction after it has been sent to the data warehouse. Because the clean up process removes the transactions, the channel resources are free to quickly process the transactions. Step 156 could be left off and there is no acknowledgment of the acknowledgment. Step 154 could be left off and there is no acknowledgment. Step 190 could be left off and there is no tracking of transactions. The clean up process can also have an archive process as well as clean up.

Drawing 3c and 3d

The electronic data channel will move the information in real-time. In FIG. 3c, the channel is bi-directional. The host channel 150 reads information from the source system 180 reads and sends information transaction across channel 152. The information like a transaction 152 comes across from the host channel to the client channel and the host channel writes information to data warehouse 190. The client server 160 sends back an acknowledgment 154 and the client server writes the information to the destination system 170 and the data warehouse 190. The host channel writes the acknowledgment in data warehouse 190, sends an acknowledgment acceptance 156 and writes the acknowledgment acceptance in data warehouse 190. Both the source and destination data warehouses have the acknowledgment, so the data warehouse performs the clean up. Step 156 could be left off and there is no acknowledgment of the acknowledgment. Step 154 could be left off and there is no acknowledgment. Step 190 could be left off and there is no tracking of transactions. The clean up process can also have an archive process as well as clean up.

Drawing 3e and 3f

The electronic data channel will move the information in real-time. In FIG. 3e, the channel is bi-directional. The host channel 150 reads information from the source system 180 reads and sends information transaction across channel 152. The information like a transaction 152 comes across from the host channel to the client channel and the host channel writes information to data warehouse 190. The client server 160 sent back an acknowledgment 154 and the client server writes the information to the destination system 170 and the data warehouse 200. The host channel writes the acknowledgment in data warehouse 190, sends an acknowledgment acceptance 156 and writes the acknowledgment acceptance in data warehouse 190. Both the source and destination data warehouses have the acknowledgment, so the data warehouse performs the clean up. Step 156 could be left off and there is no acknowledgment of the acknowledgment. Step 154 could be left off and there is no acknowledgment. Step 190 could be left off and there is not tracking of transactions. The clean up process can also have an archive process as well as clean up.

Drawing 3g and 3h

Referring now to FIG. 3g, the flow can look as follows. The host channel is the sender. The host channel reads the transaction from the source systems 180; writes the transmission 152 to data warehouse 190; and sends the transaction 152 to the client channel. The client channel is the receiver. The client channel receives the transaction 152; writes the transmission 152 to destination system 170; and writes the transmission to data warehouse 200. The client channel is the sender. The client channel reads the transaction 152 from destination system 170; archives the transaction 152; writes the transaction acknowledgment to the data warehouse 200; and sends the transaction acknowledgment 154. The channel is the receiver. The client channel writes the transaction acknowledgment to the data warehouse 190; reads the acknowledgment transaction from data warehouse 190; cleans up the channel the transaction 152 on the host channel; and sends the clean up signal to the transaction 152 on the client channel.

Drawing 3i and 3j

Referring now to FIG. 3i, the flow can look as follows. The host channel is sender. The host channel reads source system 180; writes transmission to the data warehouse 190; reads the data warehouse 190; archives the transaction 152; sends the transaction 152; and cleans up 152. The client channel is a receiver. The client channel receives the transaction 152, writes to the destination server 170, writes to the data warehouse 190, archives and cleans up the transaction 152. The client channel is a sender. The client channel sends a negative one for an error message and a zero for a successful transmission. The client channel notifies if the transmission has a problem.

Drawing 3k and 3l

Referring now to FIG. 3k, the flow can look as follows. The host channel is sender. The host channel reads source system 180; writes transmission to the data warehouse 190; reads the data warehouse 190; archives the transaction 152; sends the transaction 152; and cleans up 152. The client channel is a receiver. The client channel receives the transaction 152; writes to the destination server 170; writes to the data warehouse 200; archives and cleans up the transaction 152. The client channel is a sender. The client channel sends a negative one for an error message and a zero for a successful transmission. The client channel notifies if the transmission has a problem. The data warehouse and source system or destination is divided.

Drawing 3m and 3n

Version One

Referring now to FIG. 3m, the flow can look as follows. The host channel is sender. The host channel reads source system 180; writes transmission to the data warehouse 190; reads the data warehouse 190; archives the transaction 152; sends the transaction 152; and cleans up 152. The client channel is a receiver. The client channel receives the transaction 152; stores information to RAM; writes to the data warehouse 200; archives and cleans up the transaction 152. There is no acknowledgment.

Drawing 3o and 3p

The business, which is using the system, sets up the workflow for automated acknowledgments to be directed by the director of the data warehouse. The host channel is sender. The host channel reads source system 180; writes transmission to the data warehouse 190; reads the data warehouse 190; archives the transaction 152; sends the transaction 152; and cleans up 152. The client channel is a receiver. The client channel receives the transaction 152; writes to the destination server 170; writes to the data warehouse 200; archives and cleans up the transaction 152. The warehouse director finds that it must acknowledge the transaction. The client channel is sender. The host channel sends source system 152; writes transmission to the data warehouse 200; and reads the data warehouse 200. The host server is receiver. The host channel receives the transaction 152; writes to the data warehouse 190; and reads the data warehouse 190. The system does not have to read the data warehouse. The system does not have to do an archive. The system can re-pull the information.

Drawing 3q and 3r

The business, which is using the system, sets up the workflow for automated acknowledgments to be directed by the director of the data warehouse. The host channel is sender. The host channel reads source system 180; writes transmission to the data warehouse 190; reads the data warehouse 190; archives the transaction 152; sends the transaction 152; and cleans up 152 if necessary. If an error occurs, an error message is the written and the process stops the send and writes an error message. The client channel is a receiver. The client channel receives the transaction 152; writes to the data warehouse 200; writes to the destination server 170, archives and cleans up the transaction 152. If an error occurs, an error message is the written and the process stops the send and writes an error message. The warehouse director finds that it must acknowledge the transaction. The client channel is sender. The host channel writes transmission to the data warehouse 200; reads the data warehouse 200, and sends data warehouse system 152. If an error occurs, an error message is the written and the process stops the send and writes an error message. The host server is receiver. The host channel receives the transaction 152; writes to the data warehouse 190; and reads the data warehouse 190. The system does not have to read the data warehouse. The system does not have to do an archive. The system can re-pull the information.

Rule

The disclosed architecture tracks the source and destination points. The disclosed architecture can track to many sources and to many destinations. The rule of transferring information is that the flow of the sender must have at least one flow and that the responder can have none or more. The information can flow in sets of multiple flows. The disclosed architecture can have a data warehouse, a channel, and source system. The flow and component can vary as demonstrated above. The results are the same. The information goes from one side to the other side. The disclosed architecture does not have to initiate by the source. It can be initiated from the data warehouse. A message can be directed from the director of the warehouse to send an acknowledgment, some accounting transaction or other information. The receiver of the information to the destination system can be writing to RAM, to a variable or to a disk as permanent storage.

Flow Redirection Division

In FIG. 3s, if the process is transferring 1600 interfaces (businesses) for the GL, the host server is doing the work. Since there are 2 trillion records, the host server would be doing a lot of work. The system sends polling signals to see if the client host can do the work. It tests to see if it can do the work. If it can do the work, the client starts doing the work. It divides the transmission into 1600 pulls instead of 1600 pushes. It becomes a part of their data workflow. The work is on the client instead of the host even though the boxes are both servers. The host server 400 sends out a request 430 and 450 for the client to do the work. Both clients 410 and 420 accept the request. The client gets the data from the host server.

Machine Division

In FIG. 3t, the channel can also be divided between two machines, so GL is working on one machine and AP is working on another. The host server 500 sends the GL 530 to machine 510 and the AP 540 to machine 520.

Channel Division

In FIG. 3u, the channel is divided so GL and AP are doing different work. There are two channels and two users. The host server 600 sends the message down channel 620 GL and 630 AP to client server.

Data Division

In FIG. 3v, the channel can take a million records and divide the data into eight files. This allows the eight files to be worked on at the same time. The host server divides the file into two files 720 and 730 to client server 710.

Reroute Division

The system can reroute information. If a company has two T1, the other T1 can send and receive the information. In FIG. 3w, the host server finds 820 to be busy, so it switches to 830.

Route Division

In FIG. 3x, the route table can be auto-configured by pinging the system to set up the route. This system can also recreate the route table by setting up the accounts and the user. The system can pull their route table. The user 940 enters in the account information and the system requests the router information.

Application Division

If FIG. 3y, the system can divide the channel into two application channels. An example, if the company wants its e-mail to run free without controls, then it goes down one channel and the other applications go down another channel.

Combination of Division

The system is re-configurable. The system can route division, reroute division, machine division, data channel, application division, and data division. The reroute division can be set up. There are many different combinations of division.

Transaction Process

Another problem is the transaction process. There is the translation layout which covers the layout of the transaction. There is the translation document which covers the conversion of the file to message conversion.

Transaction Layout

The information includes a transaction number, transaction line number, transaction date, source, destination and other information. The source and destination can be placed in airline devices, ERP systems, HR systems, other information systems, any devices, and anything that needs tracking. The source and destination allow for information to be rerouted. If the destination is not where the information needs to be, the system can be rerouted. The source and destination remain the same and the forward is key is recorded. The source is notified that the information was rerouted. The source will have a message why it is forwarded. The information FIG. 2 can be forwarded numerous times. The information can be forwarded to itself. The source and destination allow for information to be a reply. The reply can be sent to the following:

To all destinations

To all sources

To all sources and destinations

To all destinations for a given date

To all sources for a given date

To all destinations and sources for a given date

To all sources for any given criteria

To all destinations for any criteria

To all destinations and sources for any criteria.

The source key can be placed in the initialization of an installation of a product. This is a wrapper. If there is no source, the information is not sent.

Transaction Documents

FIG. 5 shows sample headers and separate document transactions required for an EDI transaction. Of course, EDI has many possible document types and formatting. Suppose that the order header number is 10 and the transaction has four line items. In other words, four types of goods have been ordered with their associated attributes. For example, perhaps line 1 is syringes, and line 2 is for sponges and line 3 is a chemical and line 4 is a hazardous chemical. Because these items will not be shipped from the same source site, they must be separated into at least two different transactions. The bill of lading (BOL) header denoted by 31 shows one transaction for line items one and two. There would, of course, be other transactions with different headers for transporting line items 3 and 4. The major problem with this type of organization is that there is no way to tie the BOL back to the transaction. This is also true of purchase orders (PO) and other types of transactions. If someone wants to see what order a specific document came from, they need to manually query the order table or trace the information through a paper trail. This is a significant disadvantage of EDI. Each one of these EDI transactions needs to have a separate transaction for shipping, bills of lading, purchase orders, accounts payable, accounts receivable and other accounting items. Each separate transaction creates a header and duplicates the line items. This is a significant duplication of data that consumes resources and storage space, not to mention the confusion that is created.

FIG. 6 shows how multiple transactions are tracked for the same order using detail line items in the current disclosed architecture. This is enabled by treating every entity in the system as an account and allowing services to be a line item. Transportation services are treated with an account number just like a customer. Likewise, the supplier or wholesaler has an account number like a transportation account or shipping account. Transportation can then be treated as a service provided by that certain account. An additional advantage is the transportation information embedded in the order. In FIG. 6, four line items are shown for goods, which have been ordered and will be shipped from the vendor account 1 to the buyer account 2. Two additional line items have been included which show that line items 1 and 2 are going to be shipped to buyer 2 by carrier number 3. Then line item 6 shows that line items 1 and 2 are going to be shipped to buyer 2 by carrier number 3. Then line item 6 shows that line item order number 3 is going to be shipped through carrier number 4 to the buyer with account number 2. This is very valuable because the record always stores how those items are being transported. Information such as the source and destination or source and carrier, shown in transaction 10 of FIG. 6, are stored numerically by account. This data is combined together to make a special key that can be stored with each line number. In FIG. 6 below each account number is shown with the types of action it is allowed to perform. For example, vendor 1 has an accounts receivable system, and the data channel will be able to interface with that system

One aspect of this disclosed architecture is that a separate transaction or data interchange document with line items is not created for each bill of lading, purchase order or accounting document. In the preferred embodiment of the disclosed architecture, a single entry can be created in the transaction document controller 122 (shown in FIG. 2) without duplicating the line items or the complete transaction. This is because a document, such as a purchase order, is linked back to the original transaction. The ability to do this is facilitated by the fact that source and destination transportation information is embedded into each transaction. Avoiding the duplication of transactions with separate headers speeds up the information transfer and does not require backtracking in the data to discover which order the information came from. Using only one entry per data interchange document in the channel means only one table is created to track all types of documents. This is in contrast to an EDI system where a table must be created for each type of document which is tracked. This means there is a multitude of tables for all of the separate data interchange documents. Confusion and processing delay are usually the result of using a table for each type of data interchange. The data channel prevents the confusion and avoids additional processing overhead.

Another possible alternative configuration is to create line entries in the transaction document controller 122 for each separate line item in a transaction. This still allows the transactions to be compressed because the headers are removed but it is not as compact as referencing the transaction directly from a single entry in the transaction document controller. Yet another alternative configuration for the disclosed architecture links the transactions together with the headers for outbound or in-bound documents by using a matrix to connect the ID of the transactions together with the ID of the documents. While this reduces the overhead because the transactions are not completely duplicated, it does create another table, which is not really needed because the linking information can be contained in the lines of the transaction document controller.

FIG. 6 shows how an original source order is broken down. If source order number 1 can be shipped from a single location then that transaction will remain in tact. On the other hand, if a source order shown as order number 2 cannot be immediately shipped from a single location it will be divided into more than one part. For example, if some line items in an order must first be ordered by the shipper/vendor then they will be ordered as a separate transaction and delivered to the shipper. When vendors receive those items, they are then shipped with the rest of the order. If the line items can be shipped simultaneously from separate locations, the transaction can be separated and each part is shipped from separate locations. Suppose the buyer has ordered 5,000 syringes and 5,000 sponges, and the vendor does not have the sponges in their inventory. The transaction will be split and the sponges will be ordered from the vendor's supplier. Then when the sponges arrive they will both be shipped together to the buyer. Suppose the buyer does not have either syringes or sponges in stock but can have the line items shipped directly from the supplier's sites. Then the transaction can be split into two parts and shipped directly from the supplier's sites immediately. This disclosed architecture can do with any system and any type of transaction. It does not have to be with just orders.

Information Process

Traffic Block

The traffic block process blocks all information passing through. It gets analyzed and then routed. The entity can block certain e-mails that carry viruses and other harmful information. It checks the route of the source and destination. The server notifies the user to update the route table. The information comes in. This option can be turned off totally or partially.

Recursive Process

Today, the availability of systems that provide recursive operations of the data information are very limited, if not impossible, to find. The transactions are sent, processed, and stored. The information dies if it is processed. Most times there is a manual process that you have to go through, or a programmer has programmed these steps. The transaction director knows what data has been processed. The data is pulled again if the data has not been processed.

Redirection Process

Similarly, it is very difficult to find a system that redirects the information today, outside of electronic mail. In the router world, the router knows how to redirect. The transaction director knows how to redirect the information or recover the information that is lost. It contains a set of instructions like how to forward information. The director also knows how to forward the information.

Release Process

There are some companies that require a released process. Some companies might have employees who pay invoices. These invoices may need to be audited. There is a manager who has to review the invoices, before paying them. Other companies might not have a review procedure. There is a release period for review. It is a part of the data flow.

Consolidation Process

Another problem is that the information can not be consolidated. Each program has to do its own. The structure does not lend itself to be consolidated. If you need your PO's consolidated into one, a programmer has to write the code for you around multiple tables and create other tables to hold the information. The transactions are stored in a line-by-line format with no headers. The disclosed architecture provides transactions that can be consolidated. The process is set up to do the consolidation. An example is that items can be consolidated to packages and packages can be consolidated into a bill-of-lading. Any of the information can be consolidated with this setup.

Merger Process

In conventional systems, the information process does not allow for quick merges. The accounting firm has to come in and audit the books. The auditors have to find what bills are opened and other information about the business. Most companies spend months trying to find out the numbers from the books because everything is not centralized. The companies spend a lot of money blending their books together along with assets and inventory. The accounting structures are different between packages. Oracle Financials has a set of books and PeopleSoft has business units. If two companies have two accounting systems, the books cannot merge together in a friendly manner. The disclosed architecture can provide this information quickly. There are only a few reports needed to gather this information.

Reroute Process

Conventional systems can not reroute integration, whereas the disclosed architecture can reroute. If it knows the T-1 or other channel and devices at the end of a T-1 or other channel, the message can be rerouted. It can be rerouted to the another device on the same channel or another device on another channel.

Pause Process

Nothing hauls integration today, except the release process. The pause process can be paused by a message in the data flow.

Delete Process

Conventional systems can not delete a message. The delete process of the disclosed architecture can delete any message, since the source and destination are known, or the system can mark it for deletion and then have it reviewed.

Reschedule Process

Conventional systems can not allow for rescheduling. The disclosed system can pause and reschedule the transfer.

Acceptation Process

Conventional systems can not accept a message. Since the route table is known, the disclosed system can send certain messages to be accepted.

Hold Process

Conventional systems can not hold a message. Since the route table is known, the disclosed system can route a message to be held and then accepted.

Reprocess Process

Conventional systems can not reprocess all of their information. The transaction director of the disclosed system knows how to reprocess information. It pulls the data get again and reprocesses this information.

Reply To, Reply To All, and Forward Process

A conventional systems transaction can not be forwarded, replied to, or replied to all. The disclosed process allows the transaction to be forward, replied to, or replied to all.

Polling Process

In FIG. 3k, if the process is transferring 1600 interfaces (businesses) for the general ledger (GL), the host server is doing the work. Since there are 2 trillion records, the host server would be doing a lot of work. The system sends polling signals to see if the client host can do the work. It tests to see if it can do the work. If it can do the work, the client starts doing the work. It divides the transmission into 1600 pulls instead of 1600 pushes. It becomes a part of their data workflow.

Field Table Selection Process

The business can get table and field access to each business. Two businesses can have different access permissions.

Security Process

One type of security on the Internet is the user ID. The security of the Internet is very controversial and lacks confidence with respect to the transferring of information. The disclosed system, being an open system, can take on new developments in security. The device can also accept this system new security with any technology devices that stores information. There is a need for theft protection of information.

Countability

Each channel can have its own password and its own dedicated data area. Each business has its interchange data security. The business running the system controls all of its password security.

Tractability

The system tracks the devices, the corporate, the account, the users, the columns, the fields, the forms, the source and destinations, transaction type, and other information. This is configurable security. You track the information you need. There is the security for the destination route and for the source route. The permanent CP tracking entity will catch them. The system can track the machine, the application, the user, the serial number, the operating system, the identification card, and any other information about the transmission.

Interchangeability

The passwords, work process commerce protocol forms, users, channel, field, character, data flow, and other entities are interchangeable. The system has a hub-to-hub technology, a device-to-hub technology, a free-form-to-hub technology, and many different form-to relationships. The free-form-to-hub technology has limits to security. The free-form-to-hub technology can have different aspects. The free-form technology has its own security which the channel can recognize. The free-form-to-hub technology has no security.

The hub-to-hub technology has multiple interchangeable securities. The system can run on independent passwords. The system can run on interchangeable forms, interchangeable user IDs, interchangeable message layout, interchangeable characters, and other interchangeable technology. The system can translate the message from one language to another. The system can convert the message from one measurement to another measurement. The password can be placed on the message.

The device-to-hub technology has multiple interchangeable securities. The system can run on independent passwords. The system can run on the interchangeable forms, interchangeable user IDs, interchangeable message layout, interchangeable characters, and other interchangeable technology. The system can translate the message from one language to another. The system can convert the message from one measurement to another measurement. The password can be placed on the message.

The device implants different types of technology, e.g., smart cards, into the device. The hub can sync to the interchangeable security at will. The system just calls the device and starts the upload. The device also can be plugged into a device, and sync up to the hub.

This is an open system which can adapt to new security on the market. It can plug-in the new security, accommodate an adapter for the security, incorporate the server security, and any other methods for securing the system.

The system administrator creates multiple forms, and determines when to use the form. The information does not go out under the same form. The system administrator can change the placement of the fields and can select to encrypt the data, of needed. A form can be directed to do conversions and translations. The form does not need to be directed to do conversion and translation. The two systems can connect through a device. The system can interchange the data encryption on a schedule. The business selects different types of encryption for the form. Each form can have different way of encrypting the data.

The disclosed architecture is compatible with new security technologies by implanting interchangeable new technology components and scramblers for link-up. For example, if a regulatory body of, e.g., the U.S. Government wants to implement new security standards, and also provides the new security package, the application can be plugged into the disclosed architecture. If a new security scrambling device enters the marketplace, it will automatically be adaptable to the disclosed architecture. In one scenario, new external security similar to that introduced on network servers does not impact the performance of the disclosed architecture, since the new security will be compatible.

Multiple Levels of Security

The disclosed architecture can use the existing security, the network security and other device security. The network security has the packet security. There is standard network security and the security of the disclosed architecture like the user, the device, the corporate, the account, the tracking entity, the route, the compression, the field, the character, the channel, the password, the form, the data flow, and the transaction type. All processes add security. The fingerprints are source and destination fingerprints. The flow control is another process of security control. The system “knows” the user, server and the routers, and substantially everything about the information received.

Password on Messages Security

The message can have a password. It is easier to change the user with the transaction classification. It sends the message and the password.

Package Security

The system can package the security. The system can send the security as needed. This would not be the process of choice. It is hard not to break the security anchor security and the moving security. The system can package up the security and change it each time the information is sent.

Auto-Configuration Process

The disclosed system can auto-configure substantially everything. With its uniform structures, it makes possible auto-configuration of new hardware and software.

Table and Form Configuration

Some existing systems can auto-configure some systems. They generally only auto-configure major market systems, e.g., Oracle to Oracle or Oracle to DB2. What they do not do is configure all systems. There are no rules for text-based data. Even though the many industries think they have many different types of interfaces, there are really only two types of interfaces. There are databases and free-form text. Examples of the free-form text are the columns based and non-columns based. The non-columns based follow the director-value rule. The columns based follow the metadata rule. The databases follow the metadata rule. It generates the form configuration.

Servers Configuration

The user answers how it will be configured and it generates that server.

Users and Rights Configuration

The user sets up the users and the system generates the user's rights

Schedule Configuration

The user sets up how the transaction will be processed. Some forms are open and other forms are restricted by one or many rules.

Router Tables

The information is sent when a configuration is created to all business partners. The only thing you have to do to be a business partner is set up the corporate ID. The configuration is sent to all of the business partners. If the business changes anything to the route table, the configuration is sent. It does not send the whole entity, but sends only the part that is needed. There are a number of ways to send this information; the push method, the pull method, the accepted-with-transmit method, the accepted message, and the pull route information.

Auto-Diagnostics Process

The data channel has its own way of performing diagnostics to make sure it is run properly. It makes sure that the system is up and running.

Redundant Process

The channel and data warehouse can be setup redundantly, so the channel and the data warehouse never goes down.

Warning Process

The system warns when a message is on hold, had a problem in transferring, and other problems.

Validation Process

Another problem with the Internet is transmission validation. The disclosed system can validate its transmission because the double documentation of the records. It also has a built-in acknowledgment process.

Load Balance Process

If there are multiple routers and one route becomes overworked, the system knows how to reroute. The system will balance the load and will route the messages through the multiple routers.

Archive Process

The system can archive the message. There are multiple ways to archive. The system can archive the database. The system can also create text files.

Low Maintenance Process

The system performs processes to keep the database maintenance-free.

Analysis Process

The system analyzes the channel, the warehouse, the GUI, and other processes to study the performance, the trends, and other information.

Order Processes

There are many ways to place an order. One way is to place an item in a shopping cart and accept the order at the end of the trip. The other is to select an item and select different vendors, to collect different bids for the different shoppers, and to accept the bids the user wants. Both processes can of through approval. Templates can be created to go over the same shopping procedure. The shopper can place these on the scheduler to do repetitive buying actions.

Commerce Protocol Process

The Commerce Protocol is a creation of the disclosed architecture. No one is using this protocol. It is the language and the rules, which are needed to make commerce work more efficiently. The Business Process Commerce Protocol is the way business looks at their business. The Workflow Process Commerce Protocol is how the transaction director works.

Commerce Architecture

Commerce Overview

The commerce architecture covers all industries, all applications, and all systems. The source and destination theory takes place all around the world. It is in every business, in every transaction, in every transfer, in every communication, in every moment of every day, and in every action and reaction. It can be entertainment, medical, financial, housework, and all forms of business. The commerce architecture is the foundation to track the source and destination between any two people, or entities.

Commerce Router

Drawing 2a

The present disclosed architecture is an electronic data channel which overcomes the disadvantages of the prior art electronic commerce systems. Referring now to FIG. 2a, the data channel 100 regulates the flow of data between multiple different systems and eliminates the overhead required by EDI. Users who want to purchase an item from a source system 102 make an order through a cellular telephone land-based telephone, from a web site, a web server, email message or from other computer systems. Direct order entry through the channel processor 118 may be allowed for individual users or a transaction can be sent from other computers. A purchase request contains basic information on the items to be purchased. For example, the minimum data, such as the product item coded and types, quantities, measurement codes (size, meters, gallons, etc.) and similar data must be sent. Data channel software resides on the source systems to capture and format the raw purchase request and send that request as raw transaction entry 104 to the channel process 118. Optionally, the source systems may be programmed to format the raw transaction entries for the channel process 118. In the case of telephone orders, the software to drive the voice interaction could be stored in the channel or in the source computer system 102. The channel processor 118 will normally reside on its own server but it may be in software split between the source and the destination systems.

The raw transaction entries 104 are then converted into combination entries. They are grouped together by transaction and shipping requirements. Then the raw transaction entries 104 are converted into combination transaction entries 106. The combination transaction entries contain the transaction cost 108 based on the shipping methods to be used, the volume of goods to be shipped and the distance they will be shipped. The transaction costs can be any cost, which occurs in the system. Next, the converted transaction entries, including the cost, are sent back to the source system. This allows the cost to be displayed to the user at the time of the sale. Of course, the system may also contain a mechanism to allow the user to verify or reject the costs and the transaction if desired. The pricing system may also be located on the source system to increase the speed of the quotes while the final processing could be located on a separate computer.

If purchase and shipping costs are accepted, the combination transaction entries 106 are then converted based on the data format required by the destination system(s). This information is stored in the transaction setup module 112. For example, the data may be formatted to be sent to an Oracle or Sybase database, or to an enterprise system such as SAP or Oracle Financials. Conversions may also include EDI conversions but this is not the preferred output data format. The converted data is then transferred as a converted transaction entry 114 to the destination system 116 where other raw transaction entries are passed back to the channel processor 118 to confirm the shipment of the ordered goods. The information stored on the destination system can be accessed by phone, web pages or from other computer systems. The users of the destination system might be accountants who view what was shipped and the cost of the total shipping. Alternately, it could be a trucking company, which is shipping the orders and must view the orders to see what needs to be picked up and their shipping destination.

For example, an ordering user may want to order 10,000 pounds of a certain type of four color printing paper. First, he would enter his order through a phone, a web site or a computer, and the order would be passed onto the channel server. This is the raw information. The cost for transporting and delivering the paper based on the pick-up point and the destination point is calculated. This cost is returned to the source system and will be presented to the user at the point of sale (e.g. web page or touch-tone order entry). Once the order is confirmed then it is formatted for its destination system, which may be the trucking lines of Yellow transportation that will ship the 10,000 pounds of paper. In addition to the shipping information, accounting documents will also be generated such as purchase orders, accounts receivable, accounts payable and similar documents which will be sent to destination systems.

Once the transaction has been sent to the shipper and other destination systems, then it is moved to the warehouse databases 130. The combination transaction entries 106 will first reside in the active transaction warehouse 132. This active transaction warehouse 132 stores the transaction while it is actually being transported. The warehouse stores other information about the order such as account information, cash management, telephone conversions, addresses and claims. In essence, it stores everything that moves through the data channel. A transaction log (not shown) in the active transaction warehouse 132 tracks each point where the transported goods arrive and depart. For example, when the paper shipment arrives at certain trucking terminals or check points these would be stored in the active transaction log. The trucks may also include global positioning devices so the transaction log can reflect the real time position of any truck and shipment. After the goods have been delivered, the transactions are moved to the storage transaction warehouse 136, which is essentially an archive of completed transactions. This archival storage reduces the size of the active transaction warehouse. Both the active transaction warehouse 132 and the storage transaction warehouse 136 can be queried from the view systems 138. The view systems can be either a graphical interface through the web, other computer systems or even a telephone voice activated interface.

Drawing 2b and 2c

One aspect of the data channel is to read live orders from a source system, format them in a manner that is appropriate for a destination system and write that information to the destination. FIG. 2b also shows how the transaction data may flow in a different manner. After an order has been entered through the source system 102, it is passed as a raw transaction entry 104 into the channel. This transaction is converted to the proper format for the destination through information in the transaction setup 112. The original order is then sent as converted transaction entry 114 to the destination system.

The destination system 116 receives the order then prepares to ship the ordered items as defined by the converted transaction entries. The transactions are then sent to the active transaction warehouse 132.

As shown in FIG. 2c, when the transaction enters the active transaction warehouse 132, it is combined with additional transaction information 300. The transaction information is the account information 302 and the item information 304, which are linked with the transaction file 312. This allows the view system 130 (FIG. 2b) to be able to view the orders and accompanying line item details and account information. The transaction executor 308 is a process scheduler, which executes entry of the transactions into the active data warehouse. The transaction director 306 contains the steps that are needed to be executed on the transaction and what additional documents need to be generated, such as transportation documents, purchase orders and other information. The transaction and database processing 310 takes care of functions such as database administration and cleanup. One function of the transaction director 306 is pricing generation, which will be entered into the transactions by the transaction director 306. This pricing is generated as soon as the transaction is entered into the active warehouse. The pricing is combined into the transaction and is immediately viewable by the view systems 130. A configuration such as this allows the buyer to view the shipping cost and availability of the goods to be shipped in near real time. Then if a viewing user wishes to cancel the transaction they will have a specified time to cancel the transaction before it is actually shipped.

Drawing 2d and 2e

One aspect of the data channel is to read live orders from a source system, format them in a manner that is appropriate for a destination system and write that information to the destination. FIG. 2e also shows how the transaction data may flow in a different manner. This transaction is converted to the proper format for the destination through information in the transaction setup 314. The entry is prepared in the active transaction warehouse. It passes a raw transaction entry 104 to the destination system. The destination system 116 receives the order then prepares to ship the ordered items as defined by the converted transaction entries. The transactions are then sent to the active transaction warehouse 132.

As shown in FIG. 2e, when the transaction enters the active transaction warehouse 132, it is combined with additional transaction information 300. The transaction information is the account information 302 and the item information 304, which are linked with the transaction file 312. This allows the view system 130 (FIG. 2d) to be able to view the orders and accompanying line item details and account information. The transaction executor 308 is a process scheduler, which executes entry of the transactions into the active data warehouse. The transaction director 306 contains the steps that are needed to be executed on the transaction and what additional documents need to be generated, such as transportation documents, purchase orders and other information. The transaction and database processing 310 takes care of functions such as database administration and cleanup. The most important function of the transaction director 306 is pricing generation, which will be entered into the transactions by the transaction director 306. This pricing is generated as soon as the transaction is entered into the active warehouse. The pricing is combined into the transaction and is immediately viewable by the view systems 130. A configuration such as this allows the buyer to view the shipping cost and availability of the goods to be shipped in near real time. Then if a viewing user wishes to cancel the transaction they will have a specified time to cancel the transaction before it is actually shipped.

Commerce Channel

Channel Variance 1

The channel can be configured without the data warehouse. This configuration is not recommended. The archive process is removed. The business can not analyze the trends of their data.

Channel Variance 2

The channel can be configured where all the reformatting, the calculations, the directions, or a combination of one of the three can take place within the channel. This configuration is not recommended. It gets in the way of what the channel does best, which is transfer data efficiently and control the data flow of the data.

Channel Variance 3

The channel can have the data warehouse incorporated in it. This configuration is not recommended. It gets in the way of what the channel does best, which is transfer data efficiently and control the data flow of the data.

Channel Variance 4

The channel can reside on the source systems, destination systems, or the web provider systems. One embodiment has it residing on the source systems and destination systems. They have control of their own data.

Channel Variance 5

The channel has a router table, which is the ATCP. It contains source and destination route in the information.

Channel Variance 6

The channel can compress the data as it is sent.

Channel Variance 7

The channel can send a transaction in blocks or one transaction at a time.

Channel Variance 8

The channel can take in any data information. It could be for any industry. The data can be commerce plus non-commerce. The channel can be used to link any data between any two systems.

Channel Variance 9

The channel can have one or multiple channels. Each channel can have its own security. The GL can have is its own password if there is multiple channels or the same if there is one channel.

Channel Variance 10

The Channel can be divided into multiple different security channels. One channel can have one type of security and the other another type of security.

Channel Variance 11

The Channel has no programming or adapters. The channel is controlled by the system. The system pre-configures everything.

Channel Variance 12

The channel has one corporate set up. All route tables come through one system to create the information needed. The route tables are distributed on a schedule manner.

Channel Variance 13

The channel can be used between devices to the data hub to security the data transferred.

Commerce Warehouse

Warehouse Variance 1

The data warehouses can be one instead of two warehouses. This configuration is not recommended. It gets in the way of active and history record being together. If it is a high volume database, the user wants to view the active record at a faster rate.

Warehouse Variance 2

The data warehouse can pull information from the data of other systems instead of analyzing and creating the data to come up with the documentation control. An example is going to Oracle Financials, PeopleSoft Human Resources, and the other informational systems. This process does not collect the data in real-time. This configuration is not recommended. One aspect of the disclosed architecture is to be in real-time.

Warehouse Variance 3

The channel and the warehouse can be incorporated into any informational system like Oracle Financials. This configuration is not recommended. The Oracle Financials is a transaction-based system, the channel is routing-based system, and the data warehouses are decision-support systems. If the systems are placed together, the performance of the system goes down.

Warehouse Variance 4

The part of the disclosed architecture, such as document controller, the source key, destination key, and routing table and other information can be incorporated into the Oracle Financials or any other information system before transferring the data. This disclosed architecture does not lend to this concept because there is no control of the routing table concept.

Warehouse Variance 5

The document controller could be created by typing the data into excel spreadsheet. This is not recommended. It is time-consuming.

Warehouse Variance 6

The data warehouse can be without the data channel. This is not recommended because it bypasses some security.

Warehouse Variance 7

The EDI can add a tracking number. This will tie together.

Warehouse Variance 8

The Warehouse Director can be centralized or decentralized or a combination.

Warehouse Variance 9

The warehouse can have other processes to improve processes like the last transaction and summary of transactions and processed reported. These functions are a part of warehousing data. The warehouse can have summary, calculations, and other information created for the information gathered by the pull.

Warehouse Variance 10

The warehouse can be divided into categories that are predefined. An example is by occupation like transportation and other occupations.

Warehouse Variance 11

The data warehouse can have other systems fed into it.

Warehouse Variance 12

The warehouse can be loaded on the destination server, source server, web provider server, or another server. It can be divided on multiple servers with the same or different information.

Warehouse Variance 13

The Warehouse Director allows for easier customization of messages.

Commerce Document Server

Storing a Published Document

The document server uses an imaging server. A document can go through a high compression before being stored on the server. The document server can he just a standard server in a regular format. Documents can be stored on a combination of servers. For example, a medical document on a standard server and a patient procedure on, e.g., a Fuji Medical Server.

Retrieving a Published Document

The table of contents has the following information: transaction type of corporate, account, tracking entity, item, and document, the router number that is the CP address, document name, and any other information. The user clicks on the item and it pulls up the table of contents. The table of contents pulls up the document. The table of contents is a tracking entity and is configurable to track any information.

Creating a Published Document

The document searches for contents in content, person, places, and other categories. It reads the document into a classification. It classifies the person, place, and context. It weeds out the words you do not want classified. It classifies the document the attributes of the document. An individual reviews the classification.

Creating a Published Document Key

The CP address for the document is document.timestamp.name.author.publisher and CP address for document classification is like the library that subject.author.title. There are multiple CP addresses. There are DNA class strings.

Creating a Link

The CP addresses can be used to link information together.

Commerce GUI

The server drives the GUI and the phone book drives the GUI. The phone book was developed for a reason. The phone has a table of contents, the division of the phone book, the business type, and the individual business. In e-world, the table of contents is a site like a mall, directory, etc. The division of the phone book is the verticals like restaurants, trucking, etc. The business type is the structure of the business like India food, Japanese food, etc. The individual business is the account. The GUI is generated the GUI structure. The table of contents is stored under the business. The GUI is auto-configurable. The GUI structure is as follows:

| | | |
|---|---|---|
| Site | | |
| | Mall | |
| | Services | |
| | Tabloid | |
| | Mall | Restaurant |
| | | Women's Clothing |
| | | Men's Clothing |
| | | Hardware |
| | | Stores |
| | Restaurant | Food.Japanese |
| | | Food.India |
| | Corporate | Home of Corporation |
| | Account | Japanese Gardens on South 5 |
| | | Japanese Gardens on North 9 |

The Tracking Entity is the corporation phone book. You can unlist or list an entity. The system can have other criteria added to the directory structure. It can be processed to have this new directory structure.

Commerce Search Engine

There is a wide variety of search engines. This disclosed system comprises a search engine which searches on CP addresses. The search has the following: CP types like corporate, account, item, and document, CP tag of structure like IHCP, information type like person, place, and context, the CP classification, the level of the attribute, the attributes, and the CP item being searched. The attributes are single word and CP addresses. CP is the hierarchy. CP tag is the branch of the search like Item Size. CP classification is the Size.women.10. Size.Women and Size.10 are the search criteria. The single attributes are Women and 10. The search can now have a word and the different items that meet that word. The user can create their own search criteria and store them. An example is Search (Size.10 or Size.M or Size.11) and Part.Sweater and Color.Blue The user can save it. Search is Search.Carol.Sweater. The user can enter from the GUI. The screens can be generated to meet the user needs. It is like the CP Generator Screens.

Converter and Translator Process

There are many ways for the translator and conversion to work. There are many processes: people-to-people, people-to-system, and system-to-system. There are different numbers: one-to-one, one-to-many, many-to-many, one-to-none, and many-to-none. With conference calling, the pattern will differ. Written communication goes through devices like a computer. Verbal communication goes through device like a phone. The device depends on the verbal and written communication. There are two parts: the send and receive part. System-to-system has the following transmission: SendForm-Transmission-Translator-Conversion-ReceiverForm. The translation is but a word and parser. The receiver selects English. The sender selects Italian. Any conversion can be viewed.

Commerce Translator

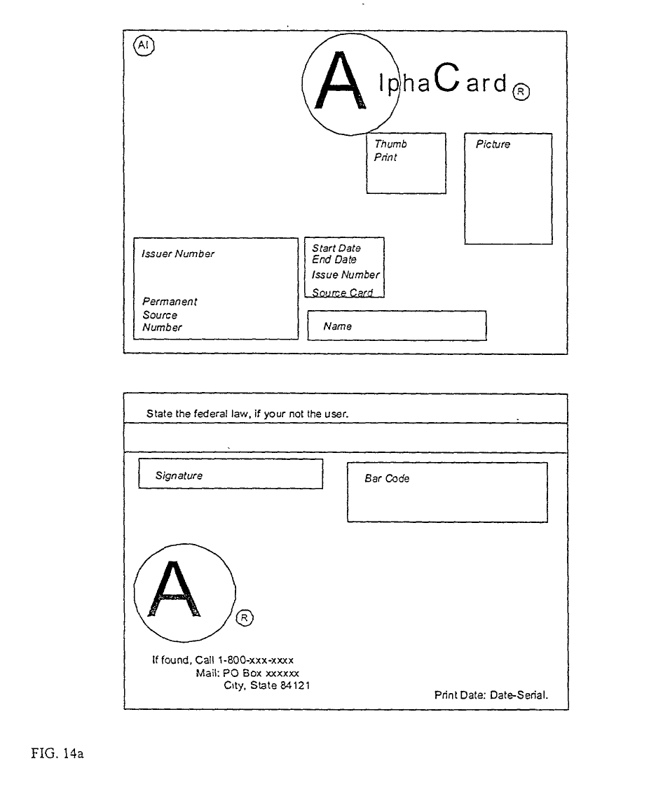

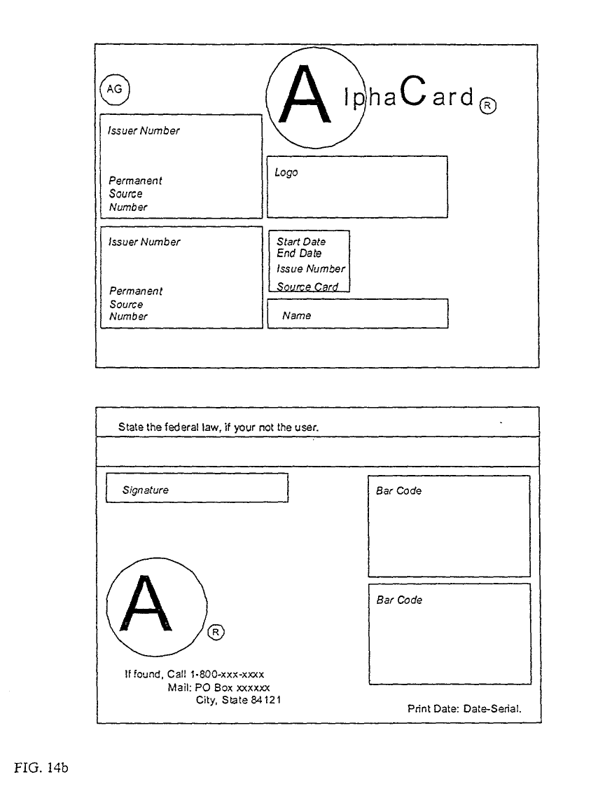

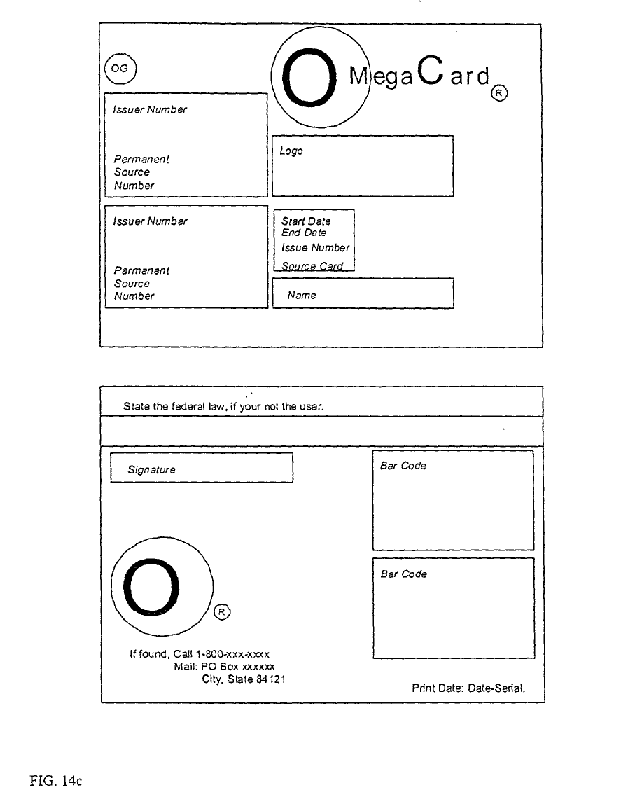

The language translator can translate the messages as they are being sent. They also translate currency in real-time and measurement in real-time. FIG. 14 shows the translation.

Commerce Converter

The commerce converter matches the numbers like social security to a new number. In FIG. 13 shows the conversion.

Commerce Generators

With uniform paths, the disclosed system can generate anything.

CP Generator

The generator creates CP addresses from anything and specific CP address as from corporate ID, account ID, tracking entity ID, item part description, birth tag, new IP address know as CP addresses, building addresses, item size, and packing size. There are certain levels. A user must have a corporate level to use this system. There is the FIG. It knows how to do the 50 states 1-50 and other countries 1 to maximum number. The system generates the screen. The users enters in the screen labels, the number of levels, and the separator. A form will direct the user to what they are entering. The data is divided into certain criteria like country to state.

Data Flow Generator

With uniform paths, the system can generate anything. The system generates the release screen code, entry screen code, hub code, transferred code, and other code that is needed.

IP Generator

The IP and DNS names go through this generator. The corporate ID number goes with the IP address. The corporate name goes with the DNS. DNS looks like the www.CompanyName.AccountName.DotComName.ext or www.CompanyName.DotComName.ext, for example, www.TheAssociates.Trucking.TheAssociates.com.

The IP address is CorporateID.AccountID.IPAddress or CorporateID.IPAddress. An example is 120.01.120.36.06. This solution will allow for the dot coms not to run out of dot coms. This solution will allow IP addresses to be extended.

Commerce Tracking Entity

The tracking entity is centrally controlled. The tracking entity is distributed to each server. The new information can be entered into the tracking entity. The tracking entity goes through a validation process before it is submitted. The tracking entity can change the configuration. The permanent IP address can be stored in the tracking entity. The system knows where all files are located. This directory structure controls route tables. The system can change the table automatically or tell the administrator to change the table manually. The information can be pushed or pulled.

Commerce Screen

The screen is told where to do the validation. The validation can be done while entering or after entry. The screen is given permissions to who can use. This is done by grading a user or by groups. The information can go through a release procedure.

### COMMERCE PROTOCOL

The disclosed Commerce Protocol does not exist in the commerce arena today. It replaces the conventional EDI protocol. It is needed to standardize Commerce. The Commerce Protocol covers the rules on how to converse with the channel, the data warehouse, and the other device interface. There are processes, hierarchies and transports. The processes include the Commerce Nomenclature Commerce Protocol, the Workflow Process Commerce Protocol, Business Process Commerce Protocol, Accounting Process Commerce Protocol, Error Message Commerce Protocol, and Search Engine Commerce Protocol.

The hierarchies are Corporate ID Commerce Protocol, Tracking Entity Commerce, Item Tracking Commerce Protocol, Vendor Number Commerce Protocol Item Tracking Commerce Protocol, and Item Attributes Commerce Protocol.

The transports are Source Route Commerce and Destination Route Commerce Protocol.

Processes

The Business Process Commerce Protocol is the way that business performs the daily activities. This is the way this business reanalyzes each business process. Each business process will be re-analyzed through this process. The Workflow Process Commerce Protocol is the way that business creates the workflow and the forms needed to direct the transaction. The Commerce Nomenclature Commerce Protocol is the way that the device talks to the channel. The Accounting Process Commerce Protocol is the way that the accounting process works. The Structure Messages Commerce Protocol is the way that the messages are transferred.

Hierarchy Structures

The structures are Corporate Transactions, Corporate Account, Tracking Entity, Corporate Item, Transaction, Document, Server, Commerce Directory, Commerce Search Engine, Commerce Accounting, Tax, Commerce Translation, Conversion, Commerce Routing, and Structure Message.

Hierarchy Components

The hierarchy deals with the following: Corporate ID Commerce Protocol, Tracking Entity Commerce, Item Tracking Commerce Protocol, Vendor Number Commerce Protocol, Item Tracking Commerce Protocol, Item Attributes Commerce Protocol, Structure Message Commerce Protocol, and Transaction Message Commerce Protocol.

Transport

The transport deals with the Source Route Commerce Protocol and Destination Route Commerce Protocol.

Process

BPCP—Business Process Commerce Protocol

BPCP is how the commerce structures change the way information is processed by businesses. The Business Process is a flowchart on how the business does business and on how the business will do business. This is an example of the BPCP.

Standard.BPCP.Account.2000041200001—Corporate Transaction

This is the body of the information. This is where the subject is described.

WPCP—Workflow Process Commerce Protocol

PCP replaced the EDI protocol. An example is ED1210 is Transportation Invoice. It may be replaced with the Bank Transfer and may be called Standard.WPCP.Bank.I.0001. The other customer may need to customize and may be called Custom.WPCP.Bank.I.0001. WPCP has a title like Standard.WPCP.Order.2000033100001. It has a transaction block like Transaction.Order.Item.ShoppingList. It has a level like select and item. It has the step to select an item. Each step corresponds to a message. A form is configurable. Each business can perform different steps. No business does business the same. The business configures their business by CP Address.

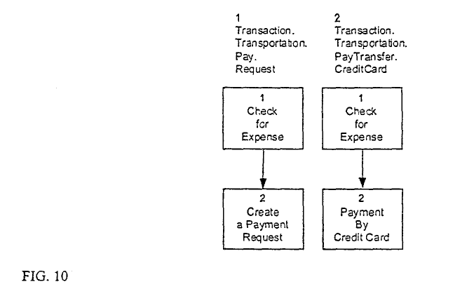

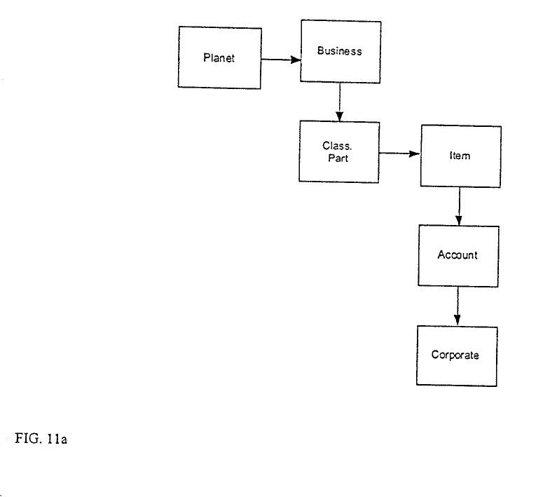

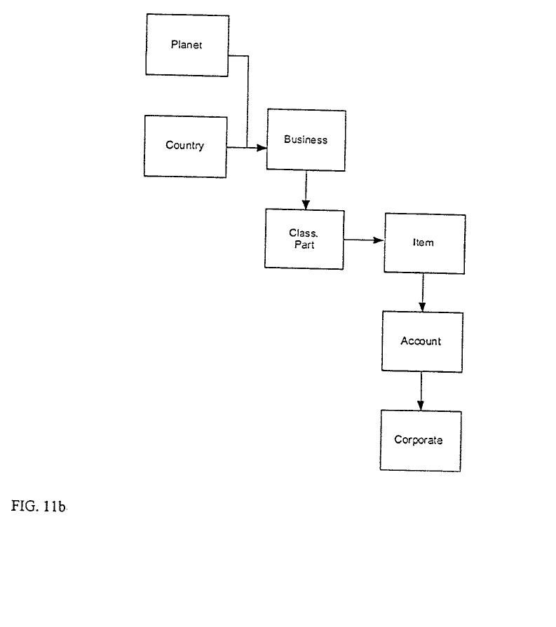

FIG. 10 shows the transportation payment. The steps tell what programs should be run. The programs go into a library. The programs go to the step.

CNCP—Commerce Nomenclature Commerce Protocol

The e-commerce, v-commerce, and e-mail have no common structure. The e-world has removed the logistics out of the creation of the internet. It is also removing the tools, which help put order to the world. There is no tie between the e-commerce, v-commerce, palm devices, and e-mail. Each business creates their way of doing it. The majority of sites are distribution and the real business structures are getting left behind. The e-distribution is virtual and is not an actual site. The human factor has been taken out of the e-business. The individual pop and mom shop can not afford the cost of the technology. It has to be affordable.

Directory Structure

One of the tools is the phone book. This structure places the logistics back to local communities as well as global. The phone has a table of contents, the division of the phone book, the business type, and the individual business. In e-world, the table of contents is site like a mall, directory, etc. The business of the phone book is the verticals like restaurants, trucking, etc. The page of phone book is the structure of the business like India food, Japanese food, etc. The individual business is the account itself.

Communication Structure

Another tool is nomenclature. The nomenclature is <director><separator><value><terminator>. The nomenclature can be altered:

<director><separator><director><separator><value><terminator>.

<director><separator><value><separator><value><terminator>.

<director><separator><director><separator><value><separator><value><terminator>.

<director><value><terminator>

<director><separator><value>

<director>

<value>

It is suggested to use more than just a value. It is difficult to tell the director unless it is implied. The URL now is as follows: www.anyword.extension\director.value\director.value. The URL can perform the search:

Anyword.extension\director.value\director.value\?Search\director.value\director.value

The free-form text is as follows:

director.value<terminating character>

director.value<terminating character>

The speed code for V-commerce has the following:

director.value*director.value*director.value#

The phone can go please select director and enter the value with terminating character of #. The header and footer are optional. The director.value can be assigned a number.

01 equals director.value or 01.02 equals director.value.

A director and a value can look like an IP address 102.3.50.1. The address can set in spread columns in a database with a key. The developer can make a director take on multiple means. The developer can add more to the in front of the director and in the back of the value. These are the two components necessary to drive direction.

Classification Structure

The classification structure classifies everything. The classification uses a DNA string. The order does or does not matter. The order depends on the string. The string looks like this: class1:class2:class3|class1:class2:class3. The separator can change. An example is planet:country:state:county:city is the USA government's DNA. Two countries do or do not have the same DNA. This string has order. The attributes of an item are

0.28 mmDitchPitch:1024X768NonInterface:FlickerFree:EnergyStarCompliant:PlugAn dPlayReady. This string has no order.

Logistic Structure

The logistic structure is source and destination. The source is known as alpha and destination is known as omega.

APCP—Accounting Process Commerce Protocol

Today, each company defines their accounting code in individual blocks. Some companies may use an accounting code like company code plus natural accounting code plus cost center plus project code and other may use an accounting code like company code plus natural accounting code plus cost center plus department code.

There are two parts of the accounting item process. There is the tracking part (or the route part) and the item part. The tracking part contains any component that is traceable, which are the employees, accounting companies, devices, department codes, and other tracking components. The item part contains any component that belongs to the item, which are the business type, the item class, the item itself, and other item components. The account code looks like this: <traceable part><item part>.

There are two parts of the accounting work process. There are two parts of the accounting item process. There is the tracking part and the item part. The tracking part contains any component that is traceable, which are the employees, accounting companies, devices, department codes, and other tracking components. The item part contains any component that belongs to the work, which are the business type, the work class, the work itself, and other work components. The account code looks like this: <traceable part><item part>.

There are two parts of the accounting transportation process. There are two parts of the accounting item process. There is the tracking part and the item part. The tracking part contains any component that is traceable, which are the employees, accounting companies, devices, department codes, and other tracking components. The item part contains any component that belongs to the transportation, which are the business type, the transportation class, the transportation itself, and other work components. The account code looks like this: <traceable part><item part>. The item part can be divided into class of the part, the unique part number, the part, or any other division that is dealing with the part. Another way is to place the total accounting code on the item.

SMCP—Structure Messages Commerce Protocol

The Smart String is a string that has Director:Values. There are many types of structure messages. There are five processes, including: Classification Messages, Warnings Messages, Error Messages, Acknowledgment Messages, and Transaction Messages. The messages have a standard structure. All messages can be reconfigured. The type of message can be configured in the different ways. The beeper message may look like the following: Type:Field1:Field2:Field3. The e-mail may look like this: Director1:Value1 and Director2:Value2. The field transfer may look like this: Column1:Field1, Column2:Field2. This system does not care how it looks.

Hierarchy Structures

The hierarchical structures are the corporate transactions, the corporate account, the corporate items, the commerce directory, the commerce documents, the commerce search engine, the commerce tax, the commerce accounting, the commerce translation, the commerce conversion, and the commerce routing.

Standard.BPCP.Account.2000041200001—Corporate Transaction

Right now, there is no way of tracking IDs to individuals, corporations, and other organizational bodies like the government. An example is that a user can have multiple IDs on yahoo.com. The user can create them at will. One individual can have multiple IDs and no one will handle the cleanup of these IDs. There is no corporation control that tracks other system vendor numbers. There are duplicate vendor numbers in most systems. There is no system administrator. There is no verification policy.

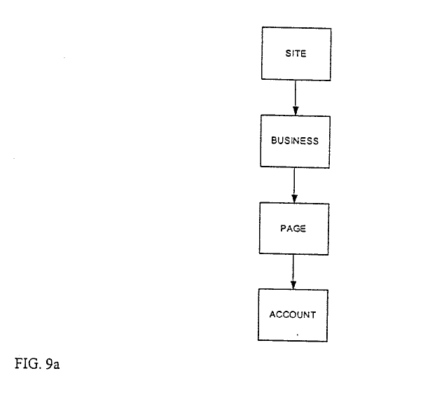

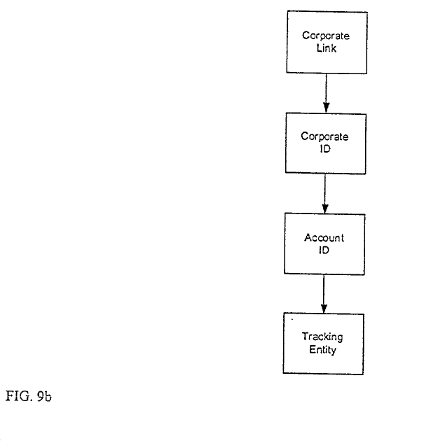

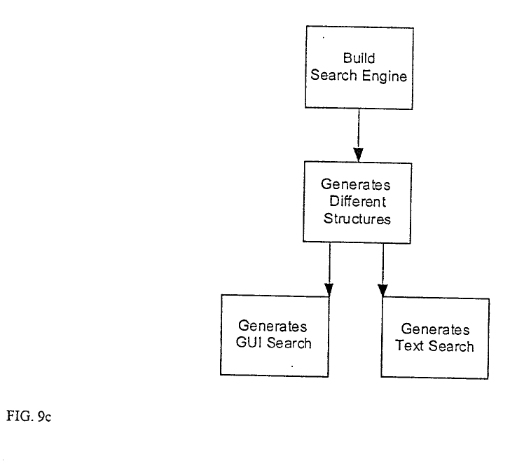

IN FIG. 9a, the CICP is the corporate ID. The TACP is the account ID, which is one location. The TECP is the tracking entities, which is the routing information. The CTCP is the transaction message. The TCCP is the where transaction are consolidated. The TTCP and TVCP are where the source and destination are tracked.

Standard.BPCP.Account.2000041200002—Corporate Account

In FIG. 9b, the account information tracks the statuses AFCP, the bank information ABCP, the approval groups TAGCP, the approval limits TALCP, the tracking entity TECP, and the item list ITCP. The approval process is TAGCP and TALCP for purchasing. The statuses are meetings and other events. The ITCP is a list of products and services.

Standard.BPCP.Account.2000041200003—Corporate Items

If FIG. 9c, the item hierarchy has the attributes IACP, the item warranty IWCP, the price of the product IVCP, the bill of material IBCP, the regulation boards IRCP, the item size ISCP, and the item packages size IPCP. The information classifies the item. The unique item IUCP and item account IALCP is the item directory.

Standard.BPCP.Account.2000041200004—Commerce Directory

In FIG. 9e, the directory structure is site, business, page, and account. In FIG. 9d, the directory structure is site SHCP and the business BHCP. The page and account are a part of the item. The IUCP is the unique item listed with the accounts that have these parts.

Standard.BPCP.Account.2000041200005—Commerce Documents

In FIG. 9f, the document structure is the document directory DLCP, the document attribute DACP, the document attributes DACP, the document exclusion words DECP, and the search engine SECP.

Standard.BPCP.Account.2000041200006—Commerce Search Engine

In FIG. 9g, the search engine has the following key information: the topic commerce key TCKCP, the search word TLNCP, and the commerce key attribute ACKCP. There is more information to the search and more hierarchy. The information given is the key information.

Standard.BPCP.Account.2000041200007—Commerce Tax

The tax structure is the world structure set up by governments. The USA has planet, continent, country, state, city, and community. The tax is placed on commodities. The information given is the key information.

Standard.BPCP.Account.2000041200008—Commerce Accounting

The accounting structure is tracking components and commodities components. The information given is the key information.

Standard.BPCP.Account.2000041200009—Commerce Translation

The translation structure is security, language, measurements, and currency. The information given is the key information.

Standard.BPCP.Account.2000041200010—Commerce Conversion

The conversion structure is the new ID to the old ID and old ID to new ID.

Standard.BPCP.Account.2000041200011—Commerce Routing

The routing of information has different levels and different structures. This disclosed architecture handles multiple levels.

Standard.BPCP.Account.2000041200012—Commerce Page

The corporate structure links other site to view the tracking entities and item entities, which have view approval. This also includes their services and products. The commerce page starts at the corporate level. There is the business structure that links business types to corporations. Both these structure make the commerce page.

Hierarchy Component

Corporate

CHCP—Corporate Hierarchy Commerce Protocol

There is no true corporate hierarchy. Every business runs independently and there is no link between two corporations. There needs to be a corporate link between two corporate divisions like Johnson & Johnson. The head of a corporation gets an account number to link multiple corporations together. The corporation can be the same or different. They can be permanent by linked or temporary by linked.

CICP—Corporate ID Commerce Protocol

The Corporate ID Commerce Protocol is stored in the address table and is the root to the protocol. To have global control of the business, each corporate must have an initial corporate location. The corporate ID uses the director, separator, value, and terminator. The values could be planet, country, state, city, type, name, and number. The CICP has the following corporate type: Corporate, Partnership, Sole Proprietorship, Family, Individual, Government, Organization, Non-profit, or other types. The CICP can be associated with a number, which makes it look like IP address. This disclosed architecture assigns the CP address to the CICP plus IP address.

Account

ATCP—Account Tracking Commerce Protocol

This is the account hierarchy.

AUCP—Account User Commerce Protocol

This is the user and group information about the system. This is a part of the tracking entity.

ABCP—Account Credit Commerce Protocol

This keeps the credit and account information to do business, such as the banking transaction.

AFCP—Account Flow Commerce Protocol

This tracks all the status information.

TALCP—Transaction Approval Limit Commerce Protocol

These are the limits that each user can approve.

TAGCP—Transaction Approval Group Commerce Protocol

This is the user and approver.

TARCP—Transaction Approval Assignment Commerce Protocol

This is the assignment on transaction purchasing limits. This is stored as tracking entity.

Tracking Entity

TECP—Tracking Entity Commerce Protocol

This disclosed architecture changes the address book into the address-tracking book. The address book becomes a list for everything, which is used to track and access. The address book is used to control all lists, addresses, devices, and other information. The address tracking stores if the address is virtual or real. These are some tracking entity types: Ship To, Bill To, Devices, System, Servers, Web Site, Contacts, Employees, Department, Accounting, Boards, and other categories. In the address book, the business can give ID Business Short Keys like the stock exchange. The Location ID uses the director, separator, value, and terminator concept. The values could be planet, country, state, city, and number. This disclosed architecture assigns the CP address to the ATCP. All addresses are assigned cost codes. The ATCP is the route table. The individuals have their birth date and place as the route number. The permanent and impermanent are the two types of IDs. The permanent type will last the life of the products, creatures, building address, etc. The permanent types will last the life of the product like automobiles, person, building address, etc. The impermanent type will be calculated by the corporate ID. These ATCP are the ship to, bill to, etc. The ATCP has their own CP address and the permanent CP is a part of our services. There is a field for the permanent CP field in the address table. The island number and coordinates x, y, and z are stored in the route table. This disclosed architecture assigns the CP address to servers the CICP plus IP address. The servers are permanent.

Human ID is planet:country:state:city:corporateID:number. The number is datetime and sequence number. The corporate ID number is the hospital number. Building Address is planet:country:state:county:city:street:streetnumber:buildingnumber:sequence. Item Number with serial number is class:description:brand:model:serial:number:date:sequence. Item Number with lot number is class:description:brand:lot number:sequence.

Now, the human can be tracked. There is no way that an individual can not be identified. There are no more unknown entities. There are six components: DNA, the fingerprints, the teeth x-rays, birth place: human ID and building address, death place: human ID and building address and the integration system. An individual owns a source card. The source card can do away with the social security card, driver license, and documents that are attached to a human being. The entity tracking holds the global coordinates.

The account control number tells which system the information came from. The tracking entity can accept new information. The tracking entity can have other business tracking entities or can reject other tracking entities.

ONCP—Other Number Commerce Protocol

This places the type of the number, other number, and TECP together.

TRCP—Tracking Regulation Commerce Protocol

These are the regulations that the tracking entity has.

Item

IUCP—Item Tracking Commerce Protocol

The Item Tracking Commerce Protocol falls under the Item Master. There is an item class number, provider assignment number, item master number, catalog number, item name, item description, item size, item packaging size and other industry numbers like RK number. All the numbers will be stored. The item is classified as Rare or Common, the Internal or External Use, and other classifications like reorder flags, which are already out there. The Rare produces go on the corporate web pages to advertise where the item can be purchased. A rare product is the cure for AIDS, transistors that are built for one of a kind, etc. The item is classified as direct, indirect, consigned, or other classifications, which tells how you can order it. The direct means the item can come straight from the inventory. The indirect means the item must go through the PO method. The consign means that an item can be consigned without paying. The item class number makes the item unique and item descriptor. The provider assignment number is the number that is just a sequence number with no description. The item master number is a number, which comes from the customer. The catalog number is the number that comes assigned to the customer catalog number. The item name is a single name for the produce. The computer equipment is the item name. The item description describes the product like Computer.Monitor.Compaq.1525. Each item description has a template. This is computer equipment template. This CP address for item description is class, product, brand, and model. The items that are systems or items that have components need to be tracked or items that the client would show components to the item use bill of material. The item for computer equipment is Computer.System.Compaq.1100. The item master has the bill of material for the item. There is classification of size. The size classification is number and the size description is Box, Tube, etc. The item specific is item master number, size, weight, season code, math type, and number. The item package has the same classification. The disclosed architecture has created item class, item size, and item package.

IBCP—Item Bill of Material Commerce Protocol

The Item Bill of Material Commerce Protocol is parenting item master number, child item master number, and quantity.

IRCP—Item Regulation Commerce Protocol

These are the regulations that an item is placed under.

ISCP—Item Size Commerce Protocol

This is the size of the item. The item is classified as follows: The item that has a shape is classified by code and type. An example is that the code is a number and the type is a box. There is the code, the size, the weight, and the math unit.

IWCP—Item Warranty Commerce Protocol

This is the warranty information.

FVCP—Item Value Commerce Protocol

This is the price of the item. The system can store or retrieve pricing.

IHCP—Item Handling Commerce Protocol

This is how to handle a package.

IPCP—Item Package Size Commerce Protocol

This is the packing size of an item.

IACP—Item Attributes Commerce Protocol

These are items used to describe it further. This is all the information about the product like the brands, models, hazard instruction, and any other information about the product. This information is a part of the search criteria.

IUCP—Item Unique Commerce Protocol

This is the item list.

IALCP—Item Account List Commerce Protocol

These are the accounts to the unique items.

Transactions

TCCP—Transaction Controller Commerce Protocol

The structure allows one or more companies or divisions to tie or consolidate any of their information together. This controller can consolidate any thing down to any level. It can consolidate any transportation costs, any orders costs, and other information. It can consolidate any of the information together.

TTCP—Transaction Tracker Commerce Protocol

The key is the SRCP that is corporate, tracking account, tracking entity, customer tracking number, customer line number, and customer date and the DRCP that is corporate, tracking account, tracking entity, transaction number, transaction line number, and transaction date.

TVCP—Transaction View Commerce Protocol

It places the customer's tracking information, the RCP of destination and source, transaction information, and timestamp in column chronological order.

CTCP—Commerce Transaction Commerce Protocol

All transactions are messages. The system allows new message types to be configured. Each line item is a message. There are 20 lines and 20 messages. The messages are sent by transaction type. It can follow EDI or CP for companies that do not have EDI. A message is made up of source information, destination information, transaction information, and other important information. Any message can be consolidated to any level. Any message can cross companies. The structure allows one or more companies of divisions to tie or consolidate any of their information together. This controller can consolidate anything down to any level. It can consolidate any transportation costs, any orders costs, and other information. It can consolidate any of the information together. The data can be reported in many ways.

This step list keeps track of what steps have been performed and what steps have not been performed. These are the steps which need to be performed. A message has a form, which the message needs to be translated to the next system. This is the setup to translate. The last transaction of a group is recorded. The user knows where the last transaction took place. There are many ways the data can be reported. There are many types of calculations. There are many ways to consolidate and reconfigure the data. All of this takes place in the channel or the data warehouse. This structure handles anything that ties to the transaction. The structure can grow with the new restrictions and new trends, and any other information that is added to the transaction.

TLCP—Transaction List Commerce Protocol

This step list keeps track of what steps have been performed and what steps have not been performed.

THCP—Transaction Hierarchy Commerce Protocol

It is one transaction header to the message. It is not needed all the time.

TSCP—Transaction Setup Commerce Protocol

This is the setup for the message to translate to the next system.

TRCP—Transaction Recorded Commerce Protocol

This is the last transaction of a group.

Directory

DHCP—Directory Hierarchy Commerce Protocol

The DHCP has a GUI interface. The disclosed architecture contains a novel data structure which creates the GUI, and a novel phone book concept to the Internet.

The disclosed architecture uses the business relationship of which there are four business directory structures: corporate, account, item, and transaction. There are two GUI structures: data and directory. There are two search structures: data and search. The server setup is by site or by business. This is where the items are listed for all businesses. The other setup is by business, by page or by account. This is where the actual data is held.

There are two types of information of items: rare and common. There are two types of sites: central and distribution. The central site holds only rare information while the common site holds only common information. No one goes to Boston to buy a hammer when there is a least one place near by to buy a hammer in Dallas.

There are other ways to distribute information. This is the planet, country, the state and the city.

SHCP—Site Hierarchy Commerce Protocol

These are the sites like services, the mall, the tabloid, and other sites.

BHCP—Business Hierarchy Commerce Protocol

This is the business under a site.

PHCP—Page Hierarchy Commerce Protocol

The page is dividing the business into categories.

PTCP—Site Hierarchy Commerce Protocol

The page type is the list of page types.

Search

SECP—Search Engine Commerce Protocol

Search engines are plentiful. This search engine searches on CP addresses. The search has the following: CP types like corporate, account, item, document and other CP types, CP tag of structure like IHCP, CP tag description, CP address level, CP string, CP link, category description like person, place, and context, and the attributes. The attributes are single word and CP addresses.

TCKCP—Topic Commerce Key Commerce Protocol

The topic commerce key is the topic classification. It uses the CP addresses.

TWCP—Topic Word Commerce Protocol

This is the topic word.

ACKCP—Attribute Commerce Key Commerce Protocol

There are attributes like the item, document, account, and other attributes.

Document Structure

DLCP—Document List Commerce Protocol

This is the directory of the documents.

DACP—Document Attribute Commerce Protocol

These are the attributes or words.

DECP—Document Exclusion Commerce Protocol

These are the words that need to be excluded.

DUCP—Item Unique Commerce Protocol

This is the document list.

DALCP—Item Account List Commerce Protocol

These are the accounts to the unique documents.

Transport

SRCP—Source Route Commerce Protocol

The concept of source does not exist in the routing of the information system. There can be the creation of the source input, like a card, entry, stored or other form. The information can be incorporated in other systems like ERP systems, pipeline systems, financials systems like charge cards, and all other information systems.

The source system can route to multiple destination systems. Information can come from multiple source systems.

DRCP—Destination Route Commerce Protocol

The concept of destination does not exist in the routing of the information system. There can be the creation of the destination input, like a card, entry, stored or other form. The information can be incorporated in other systems like ERP systems, pipelines systems, financials systems like charge cards, and all other information systems. The information can reroute to another destination. There is the option to replace the source and destination system and then reroute to another destination or just reroute to another destination system. The source is notified that the information was rerouted.

Commerce Source

Source Route Commerce Protocol (SRCP) Permanent ID

There are many permanent IDs. The structure can be similar or different. New information can be added when necessary. The source permanent ID brings order to the world. The number can be modified. The number can come part from the manufacturer and part from the customer. The permanent number can have other components added to it. The permanent ID can have a random number added to it. The random number can be a combination of numbers. The number can be modified. The number can be part from the manufacturer and part from the customer. The permanent ID ties the data together with other databases. These are DNA class strings. They are configurable. The permanent IDs can go in smart cards, paper cards, paper cards having magnetic strips, smart chips, software, and other forms of tracking.

Standard BPCP.SRCP.2000042100001—Entity SRCP

Animal SRCP

There are x, y, and z coordinates. The longitude is x, latitude is y, and the distance from the sun is z. The identification number has the issuer's logistic string, issuer's corporate ID, item's logistic string, item's corporate ID, account ID, and a number. The account categories are human or animal types like dog and the account type is dog. The number is the category, the type, the logistic string, the tag type ‘T’ and tag number or ‘H’ hospital type and hospital number; time stamp; and sequence. The logistic string has the universe, the galaxy, the planet, the country, the state, and the city. The corporate ID is logistics string, corporate type, corporate filing date, and sequence. The account ID is account control number, account number, account category, account type and account address. The tag number is used if the birthplace is unknown. The hospital number is used if the birthplace is known. The corporate ID is the issuer.

Building SRCP

There are x, y, and z coordinates. The longitude is x, latitude is y, and the distance from the sun is z. The identification number has the issuer's logistic string, issuer's corporate ID, item's logistic string, item's corporate ID, account ID, and a number. The account category is building and account type is residential, commercial, and other building types. The logistic string has the universe, the galaxy, the planet, the country, the state, and the city. The corporate ID is logistics string, corporate type, corporate filing date, and sequence. The account ID is account control number, account number, account category, account type and account address. The number is the category, the type, the island number, the logistic string, the street, the number, the building number, the room number, other information, time stamp and sequence. The corporate ID is the issuer.

Certification SRCP

There are x, y, and z coordinates. The latitude of the location source number is x, the longitude of location source number is y, and the distance from the sun is z. The identification number has the issuer's logistic string, issuer's corporate ID, item's logistic string, item's corporate ID, account ID, and a number. The certification is the account category and the account types are CPA and other certification types. The corporate ID is logistics string, corporate type, corporate filing date, and sequence. The account ID is account control number, account number, account category, account type and account address. The logistic string has the universe, the galaxy, the planet, the country, the state, and the city. This number is the category, the type, logistic string, the certification number, time stamp and sequence. The corporate ID is the issuer.

Regulation SRCP

There are x, y, and z coordinates. The latitude of the location source number is x, the longitude of location source number is y, and the distance from the sun is z.

The identification number has the issuer's logistic string, issuer's corporate ID, item's logistic string, item's corporate ID, account ID, and a number. The regulation is the account category and the account types are FDA and other regulation types. The corporate ID is logistics string, corporate type, corporate filing date, and sequence. The account ID is account control number, account number, account category, account type and account address. The logistic string has the universe, the galaxy, the planet, the country, the state, and the city. This number is the category, the type, logistic string, regulation number, time stamp and sequence. The corporate ID is the issuer.

Vehicle SRCP

There are x, y, and z coordinates. The latitude of the location source number is x, the longitude of location source number is y, and the distance from the sun is z. The identification number has the issuer's logistic string, issuer's corporate ID, item's logistic string, item's corporate ID, account ID, and a number. The Ford, Olds, and other vehicle types are the account categories and the account types are Mustangs and other vehicle types. The corporate ID is logistics string, corporate type, corporate filing date, and sequence. The account ID is account control number, account number, account category, account type and account address. The logistic string has the universe, the galaxy, the planet, the country, the state, and the city. This number is the category, the type, logistic string, vehicle number, time stamp and sequence. The corporate ID is the issuer.

Standard BPCP.SRCP.2000042100002—Material SRCP

These classifications deal with the material sources. There are multiple material processes. They are all identified and set up. Since this system is re-configurable. The codes have CP addresses. The user just creates a new CP addresses.

Material SRCP

The system loads by corporation. A corporate account is created. An example is K-mart, Wal-Mart, Dollar General, and other stores, which are located globally. The corporation loads all items. The items are classified by the CP address. There is an item class number, provider assignment number, item master number, catalog number, item name, item description, item size, item packaging size and other industry numbers like RK numbers.

The class for a computer monitor belongs to the group of equipment and computer. It also belongs with another group of system and computer. The division is system and equipment. The part is a computer. The part consists of the computer; the part type is monitor; the brand is Compaq Presario; and model is model. The part has different classifications. The Item Size is as follows: 01 is box, 02 tube, and other shapes. The unique item number classification is class, the part, the size, the weight, the unit of measurement, the color, and the sequence number. The item size classification, which is the directive, is as follows: the shape type is box; the math type is metric; the shape is height, width; and length. The smallest unit is millimeter. The packaging size is as follows: box, tube, and other shapes. The item weight classification, which is the directive, is as follows: the math type is metric; the weight is units. The smallest unit is millimeter. The unit of measurement classification, which is the directive, is as follows: the unit of measurement is each; the package of units is one unit; the smallest unit is each; and smallest number is one. The package information is classified the same way as the item size. The color classification is as follows: the standard color and the manufacture color. The catalog number classification is the group catalog and catalog number and catalog sequence. The part number is the date, the item sequence, and the component sequence. When an item is sold, the system creates the following string: the serial number, the lot number, the expiration date, and warranty flag. When the warranty flag is yes, the directive is warranty, the item part number, the unique part number, the date sold, the source that sold the product, the source that produced the product, and the source that bought the product. The item order flags are the internal, the external, the seasonal code, the reorder, the reorder time, the inventory subtraction, the rarity of the item, reusable, discard after use, grade levels and other information that deals with an order. The corporate structure must have at least one account structure. The account structure has at least one tracking entity. The tracking entity is as follows: the corporate type, the corporate ID and sequence maps to the account type, the account ID, and the address number. The tax and directory structures will allow for other numbers to be tracked with it. The organization numbers can be changed as follows:

The universe view is the universe.

The galaxy view is the universe and the galaxy.

The planet view is the universe, the galaxy and the planet.

The continent view is the universe, the galaxy, the planet and the continent.

The country view is the universe, the galaxy, the planet, the continent and the country.

The state view is the universe, the galaxy, the planet, the continent, the country, and the state.

The county view is the universe, the galaxy, the planet, the continent, the country, the state, and the county.

The city view is the universe, the galaxy, the planet, the continent, the country the state, the county, and the city.

The CP addresses are stored in description and in number to be more universal. Each country can read numbers. The global directory structure is planet, the country, the state, and the city. The source card uses the universe, the galaxy, the planet, the country, the state, and the city. The tax is the item class plus sum of universe, galaxy, planet, continent, country, state, county, and city.

Standard BPCP.SRCP.2000042100003—Disaster SRCP

The disasters have lightning, volcanoes, hurricanes, tornadoes, floods, drought, fires, earthquakes, bombs, terrorist attacks, and other disasters.

Weather

There are x, y, and z coordinates. The latitude of the location source number is x, the longitude of location source number is y, and the distance from the sun is z. The identification number has the issuer's logistic string, issuer's corporate ID, item's logistic string, item's corporate ID, account ID, and a number. The weather is the account category and the account types are lightning, volcanoes, hurricanes, tornadoes, floods, earthquakes, avalanches, and other weather types. The corporate ID is logistics string, corporate type, corporate filing date, and sequence. The account ID is account control number, account number, account category, account type and account address. The logistic string has the universe, the galaxy, the planet, the country, the state, and the city. This number is the category, the type, logistic string, weather number, time stamp and sequence. The corporate ID is the issuer.

Emergency

There are x, y, and z coordinates. The latitude of the location source number is x, the longitude of location source number is y, and the distance from the sun is z. The identification number has the issuer's logistic string, issuer's corporate ID, item's logistic string, item's corporate ID, account ID, and a number. The emergency is the account category and the account types fires, bombs, terrorist attacks, and other disasters. The corporate ID is logistics string, corporate type, corporate filing date, and sequence. The account ID is account control number, account number, account category, account type and account address. The logistic string has the universe, the galaxy, the planet, the country, the state, and the city. This number is the category, the type, logistic string, emergency number, time stamp and sequence. The corporate ID is the issuer.

Standard BPCP.SRCP.2000042100004—Universal SRCP

The universe has the sun, the moon, the stars, the comets, the planets, the asteroids, meteors, and other universal properties. There is order with stars, planets, sun, comets and other order items. There is non-order with the asteroids, meteors, debris, and other non-order items. Other structures can be defined.

Sun

The sun is the center of the universe. The items are measured from the sun. There are x, y, and z coordinates. Zero is x, zero is y, and zero is z.

Planets

The planets are Earth, Jupiter, Mars, Venus, Mercury, Pluto, Saturn, Neptune, and other planets. Each planet has its own order. Earth structure is described. The planets are the account category and the account types are what the corporation is tracking and other types. The moon is an example. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy and the planet. The number is the category, the type, logistic string, and planet number. The corporate ID is the issuer.

Moons

The earth has one moon. The order is earth and the moon name or number. Moons are tracked by planet.

Stars

There are multiple stars. The order has order around the sun. The stars have different grades by their brightness. The stars have constellations and constellations give star numbers. The stars are graded. The stars are the account category and the account types are constellation or other types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy and the constellations. The number is the category, the type, logistic string, and star number. The corporate ID is the issuer.

Comets

There are comets. They have names. The comets are the account category and the account types are the names. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy and the comet. The number is the category, the type, logistic string, and comet number. The corporate ID is the issuer.

Standard BPCP.SRCP.2000042100005—Communication SRCP

The devices are owned by the source. The individual, organization, governments, corporations, partnership, and other bodies. The source card that buys the devices owns the device. The account is the location of the device. It is tracked under the account. The corporate source card is the corporation plus the account. This architecture allows for one number per one source. The fax, cell, and digital phones have one number. There are space shuttles, space stations, satellites, airlines, phones, pagers, web sites, servers, computers, printers, stock exchange, and other forms of communications. With this structure, the device can have multiple stations. An example is the pagers. The messages just come in with no divisions between the messages. The messages come from Microsoft, Weather.com, work and other places. E-mail goes to one big inbox.

Space Shuttles

There are x, y, and z coordinates. The latitude of the company source number is x, the longitude of company source number is y, and the distance from the sun is z. The space shuttles are the account category and the account types are the types of space shuttles. The identification number has the corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the space shuttles number. The corporate ID is the issuer.

Space Stations

There are x, y, and z coordinates. The distance from the earth is x, 0 is y, and the distance from the sun is z. The space stations are the account category and the account types are the types of space shuttles. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the space station number. The corporate ID is the issuer.

Satellites

There are x, y, and z coordinates. The distance from the earth is x, 0 is y, and the distance from the sun is z. The satellites are the account category and the account types are weather and other types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the satellite number. The corporate ID is the issuer.

Airplanes

There are x, y, and z coordinates. The latitude of the company source number is x, the longitude of company source number is y, and the distance from the sun is z. The airplanes are the account category and the account types are MD80, 737, 757 and other airplane types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the airline number. The corporate ID is the issuer.

Phones

There are x, y, and z coordinates. The latitude of the company source number is x, the longitude of company source number is y, and the distance from the sun is z. The phone is the account category and the account type is fax, digital, analog, cellular, and other phone types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the phone number. The corporate ID is the issuer.

Pagers

There are x, y, and z coordinates. The latitude of the company source number is x, the longitude of company source number is y, and the distance from the sun is z. The pagers are the account category and the account types are digital, and other pager types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the pager number. The corporate ID is the issuer.

Web Sites

There are x, y, and z coordinates. The latitude of the company source number is x, the longitude of company source number is y, and the distance from the sun is z. The web sites are the account category and the account types are employee, accounting, consumers, and other web sites types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the web site number. The corporate ID is the issuer.

Servers

There are x, y, and z coordinates. The latitude of the company source number is x, the longitude of company source number is y, and the distance from the sun is z. The printers are the account category and the account types are Unix, NT, and other server types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the server number. The corporate ID is the issuer.

Computers

There are x, y, and z coordinates. The latitude of the company source number is x, the longitude of company source number is y, and the distance from the sun is z. The computers are the account category and the account types are Dell, Compaq and other computer types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the computer number. The corporate ID is the issuer.

Printers

There are x, y, and z coordinates. The latitude of the company source number is x, the longitude of company source number is y, and the distance from the sun is z. The printers are the account category and the account type is dot matrix, laser, and other printer types. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the printer number. The corporate ID is the issuer.

Stock Exchange

There are x, y, and z coordinates. The latitude of the company source number is x, the longitude of company source number is y, and the distance from the sun is z. The printers are the account category and the account types are the types of stock exchange. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the category, the type, the logistic string, and the stock exchange number. The corporate ID is the issuer.

Equipment Tracking

There are x, y, and z coordinates. The latitude of the company source number is x, the longitude of company source number is y, and the distance from the sun is z. The equipment types are the account category and the account type is model and other equipment information. The identification number has the issuer's logistic string, issuer's corporate ID, item's logistic string, item's corporate ID, account ID, and a number. The corporate ID is logistics string, corporate type, corporate filing date, and sequence. The account ID is account control number, account number, account category, account type and account address. The logistic string has the universe, the galaxy, the planet, the country, the state, and the city. The number is the logistic string, the time stamp and sequence. There are places for the permanent ID. There are places for the location. The corporate ID is the issuer.

Commerce Process

Commerce Process

The commerce process is re-configured to change with the times. If something does not work, it is re-analyzed and re-configured. There are hundreds of processes that this product changes.

Corporate Process

Merger Process

Standard BPCP.Account.2000032700002—Corporate Consolidation

There are also problems when corporations merge. They have to recreate IDs and move data. The process disrupts a corporation's business. The merger costs companies a lot of money to merge. If they had the same structure, it could move their data together without much effort. There is effort in tracking assets. If the businesses were under the structure, it would not cost as much. There is corporation hierarchy. The disclosed architecture now can consolidate the information between companies that are related and are not related.

Standard.BPCP.Account.2000032700003—Corporate Clean Up

There is no clean up process in today's systems.

Total Clean Up

The system sets the Corporate Hierarchy Commerce Protocol to disable. The system de-actives the account. The process cleans up the data.

Partial Clean Up

The system marks the records that need to be deleted, moves the data to a new partition; and rename the partition.

Standard.BPCP.Account.2000032700004—Corporate Move

There is no move process in today's systems. The system sets the Corporate Hierarchy Commerce Protocol to move. The process generates the information into their system. It checks the information that may have changed. The data is marked for de-activation, is backed up, is cleaned up, and is backed up.

Standard.BPCP.Account.2000040600001—Merger Process

There are three ways to handle a merger: The corporate IDs are tied together. The reports are done separately. The system can move the tracking entity information and can leave the transactions where they are. The new transactions go to the new tracking entity. The history is back on the old system. The system can move the tracking entity and can move the transactions. The two businesses are moved together totally.

Source Card Process

Standard BPCP.SRCP.2000040100001—Source Card

Overview

The Source Card is the birth certificate card. The Source Card has the human ID plus a random sequence number plus a password. The source card has to have inside security to recognize that it is not forged. The card should have security like our monetary system. The card has embedded symbols and keys. The Source Card can have multiple ways of creating passwords. The card is with you until closure. It is closed off at death. The Source ID is closed off after inheritance is closed; bills are paid; accounts are closed or transferred; and taxes are paid. A legal document closes the source Card and a death certificate will close a source ID. A legal process can close a corporation ID, when the entity does not exist any more. The source card is sent a notification when a person dies. It is known as Omega Signal. The source company releases that information when they do some investigation. The hospital is not notified when you die, so they do not close off your birth certificate. The person has to have multiple IDs to get a source card like birth certificate, driver license, or other forms that are used to get employment.

Operations

How does the source card work? The Source Card can have multiple ways of tracking information. The system can have passwords that are two-way. The card has one and the system has one. The two get together and make up a password. The system has a one-way password. The card can have a password or the system can send a password. The system does not have to have a password for all transactions. An example is buying groceries in a grocery store. The consumer wants to track that information, but the store does not need validation for payment. The information can be sent to the consumer. The system has no password. This use is when you are entering a building. The source card is used with other IDs. The source is a validation reference. The source card is a human identification card. It is not a financial card, patient card, a driver license, a fishing license and all other forms of IDs. It is the validation card. It knows the individual. It does not know the business. It is an electronic birth certification.

Issuing the Card

This card is known as the AlphaCard. It has an expiration date of one year. The renewal is the way the census is taken. The validation process asks for the location. Now, census is done each year, instead of every ten years. The money can be redistributed each year instead of every ten years. There is no mail and no census. The source company collects all information. When a new ID is issued like a driver's license, credit card, guns, or any tracking component, it comes to the source company to verify this information. This is your address, age, and all information other information. The source company could store all information, such as voice, fingerprints, and picture when the card is issued.

Permanent Tracking Numbers

The source company helps corporations and individuals create a permanent source number. An example of a permanent source number is the human ID. The main number is planet:country:state:city:hospital:timestamp:sequence. The hospital is human birthplace. The permanent Corporate ID is mandatory. The rest are optional, but no tracking ability. There are multiple classifications.

Account Tracking Numbers

An example of an account is how the corporations, individuals, devices, and other information are tracked. An example is that employee is an account type. The hierarchy is corporate ID plus account ID. The permanent key links corporations together.

Destination Card Process

Standard BPCP.DRCP.2000040100001—Destination Card

The destination card is a pre-allocated card. The card is linked to the source individual or group card. The destination card can pre-allocate the cost of the purchases. Meals are $50.00 per day or lunch is $10.00. The business can pre-allocate limits. A code ties to the charge. An example 11 is airline, 12 is rent car, and 13 is other transportation. A destination card can be tied to a PO, a credit card, or all other forms of payment. If payment goes higher than what is approved, the business can override. It will know who overrides the cost or the source can pay the difference. Now, all businesses are linked together with the process. It links hotels, restaurants, transportation, and any other forms of businesses together.

The costs are allocated. The system goes out and checks to see if they can make the purchase. The cashier enters in the destination card. The source enters in their source card and their password. The system approves the source by giving an approval code. The destination gets charged the purchase. It can be allocated by blocks of time over a finite time. It can be allocated by a quarter at a time. The items can be allocated like lunch is 12-4. There is an expiration date or lifetime membership. The destination card knows the source card that can use it. The destination has the individual source or the source group.

Source and Destination Process

Version One

The source and the destination can have a group tie them together. The source card has individual alpha and group alpha and the destination card has individual alpha and group alpha. The group alpha is the same.

Version Two

The source and the destination have no group alpha. The source and the destination are tied together.

Version Three

There are three source, group, and destination. The source card is separate. The group source card has the source and group. The destination is given.

Version Four

The source, group, and destination can be on the same card.

Version Five

The group and destination are tied together on one card. The source card is separate. The source has to know the group and source.

Version Six

The source card can have multiple groups.

Version Seven

The destination card can have multiple groups.

Version Eight

The source, destination, and group can be in any combination.

Scan Process

The ScanItCard allows the CP addresses and other information like descriptions go on a card. The user can use a scan to enter the information. These cards can be created by request. It has bar codes.

Load Process

For the server

The site starts the server division. An example of a site is a mall, distributor, and many others. If the site server data is too large, the administrator can move the data down the chain of the directory. The lowest level is the account level. The tracking entity is the directory page. The user can pull up the directory page. Then, the user can click on the site that he wants. Business can customize the page. The source company will classify each web site. An example is computer:accounting and another is sex:models:brides. The business can accept sites computer and accounting and can reject sex, models, and brides.

For the GUI

The GUI is loaded using the business division. The item gets the corporate or account level for classification and the business gets the list of items.

For the Item

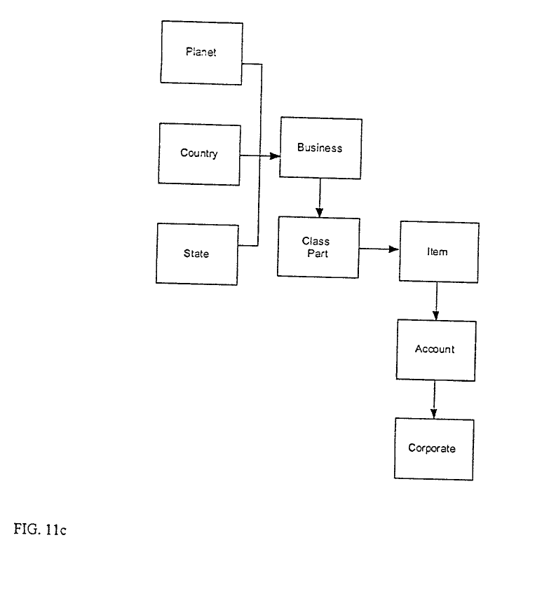

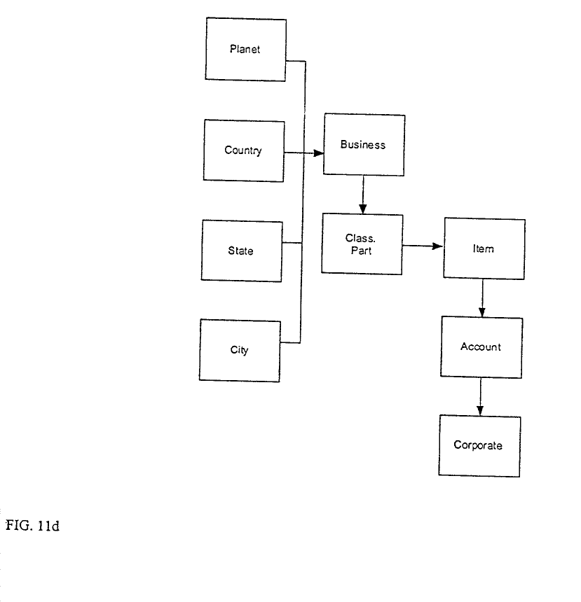

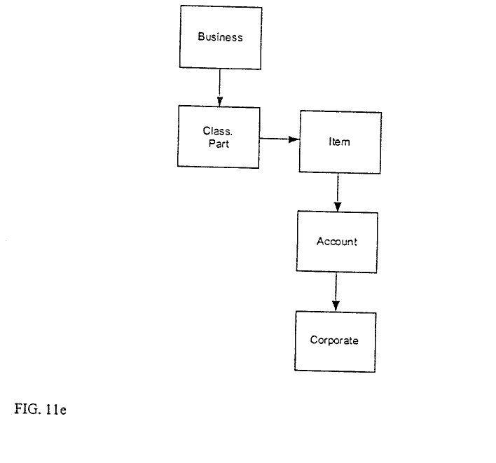

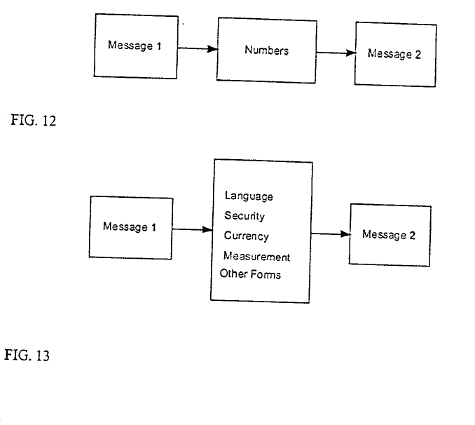

In FIG. 11, the system takes the Item Master. The system loads the item numbers. The classification takes in the item master. It shows how the information moves up the hierarchy. The system or user classifies the item description, the item shape, the item packages sizes, and other information. Then, the system or the user enters the rest of the information. The data can be consolidated as the user moves up the chain. The city has the detailed view while the state has a more consolidated view.

Commerce Product

Corporate Products

Commerce Translator

The translation takes data from one to another. The translator from one language to another in real-time. It can be a part of the server or can stand on its own.

Commerce Router

The router is the whole product. The product is the Commerce Channel and the Commerce Warehouse.

Commerce Screen

The commerce screen is a product that generates screen on demand.

Commerce Web Director

The commerce web directory is a service. This is the phone book directory.

Commerce Route Directory

The commerce route directory is a product to control all the routers.

Commerce Warehouse

The warehouse is a product that stands on its own. It does not have the channel.

Commerce Channel

The channel is a product that stands on its own. It does not have the warehouse.

Commerce Work Flow

The commerce workflow is a service. The service helps set up the accounting, the messages, the forms, the routes and any other part of the system.

Source Card

Individual

In FIG. 14a, it shows the individual AlphaCard. The source has the human ID plus the random sequence plus an expiration date plus PIN. The card is like a credit card. The card uses products that already exist. The products that it uses are card readers. The card has a metal part with the number embossed like military dog tag. If someone is burned, the plastic will melt, but the metal will not. It has your picture on the card. AI stands for Alpha Individual. The thumbprint and the picture are on the card. It has the start date and the end date. It states that it is a source card. It also has an issue number. The back states the federal law, if used by the wrong user. The magic strip and the signature are on the back. The back states where to mail if lost. The company serial number is also on the back. The bar code is on the back.

Group

In FIG. 14b, it shows the group AlphaCard. The source has the group ID plus the random sequence plus an expiration date plus PIN. It has the human ID. The source card has the individual source information. Group source does not have metal plates. The user enters the group card, then the source card and the password. The company source number and group number is on the front. The company logo is on the card. It has the start date and the end date. It states that it is a source card. It also has an issue number. It has the bar code. The back states the federal law, if used by the wrong user. The magic strip and the signature are on the back. The back states where to mail if lost. The company serial number is also on the back. The bar codes are on the back. There are four group cards. First, this is the company group card for similar rights. Second, the group card has the card per visit. Third, this is the company policy card. Fourth, this is the destination card.

Cards

The card expires each year. The destination has zero to multiple passwords. The passwords can be on the card, in the system, or both. The source card can contain your fingerprint (one or more). The card can contain your picture and the card can contain your voice. The source card can have any information on them. They can have all the security of the monetary system and the credit and debit system.

Destination Card

In FIG. 14c, it shows the OmegaCard. The destination card has the source ID. It has the corporate ID plus the account ID plus the tracking entity ID plus sequence. It has an expiration date. The destination has zero to multiple passwords. There is a renewal code. The lifetime membership expires each year. The destination card is a group card. The destination card can have any information on them. They can have all the security of the monetary system and the credit and debit system.

Item Source Cards

These are cards that store the CP addresses, descriptions, bar codes, and any other information needed. The CP addresses are scanned into the computer. An example is the unique classification of items, which is scanned as the items are being packed.

Commerce Open System

A commerce open system allows for multiple configurations. The disclosed architecture does not change because a new process is defined, but conforms the business' needs. The system does not conform to the system's needs. Here is an example of each section open view of an open system. Open systems can take many forms. This open system is fully re-configurable. The term “open” implies re-configurable, re-routable, and versatile, and means that a business can perform its day-to-day business using the disclosed architecture. The commerce open system is also flexible in that it is compatible with other technologies.

Commerce Structure

Data Flow

The data flow can be configured to an another process added in. There is little to no programming. Most businesses have this data flow. The release process can be bypassed. There is a way to connect the data flow. The system knows how to handle its data flow. Drawing another process in the flow does not change the disclosed architecture. Removing a process from the data flow does not change the disclosed architecture. The change in the transmission process does not change the disclosed architecture because it is re-configurable.

Transaction Process

The transaction process along with the configurable message process makes every message traceable. The source and destination messages can take any form. The system has a system log of all messages and what message was transferred. There is a message that shows its hop process. The system knows the source and destination. It also has all tracking entities. The change in the transaction process does not change the disclosed architecture because it is re-configurable.

Transmission Process

The transmission process can vary. The configuration manager directs the message path flow. The message can go in multiple directions and in multiple locations. The message can bundle in one message or can have many messages. The director knows the direction of the messages. The change in the transmission process does not change the disclosed architecture because it is re-configurable.

Information Process

The information process can have any combination of the information flow. The information process has plug-ins. A new plug does not change the disclosed architecture. An example is that the change can count the number of times a message is transmitted in a day. It does not change the disclosed architecture. The disclosed architecture can reject a message. The information process takes on all the attributes of systems that are out there. An example is that it takes on all the attributes of a router because the disclosed architecture is a router. It takes all forms of messages because it takes on all messages. An example is it takes on the EDI transmission format as well as the E-mail format. It also takes on the messages phone messages structure because it stores phone messages. This system is the message brain behind every message sent. The change in the information process does not change the disclosed architecture because it is re-configurable. If the world creates another messaging process, this disclosed architecture can embrace that new process. The information process can be configured to take on a new set up. The disclosed architecture can look at the new system and makes recommendation. The user can accept these recommendations. The user can re-configure the system by using his knowledge.

Commerce Architecture

Commerce Overview

The disclosed architecture controls various components. All components are already a part of the world. The number of components does change not the architecture of the product. An example is a business may want one warehouse, they configure one warehouse. The business wants different tracking entity tables. The system has different entity tables. The business different summary tables on the warehouse. The system has different system tables. The architecture is the open system policy. If business wants programs in COBOL, the programs are in COBOL. If the business is an NT operating, the system is NT. This is a fully compliant open system. The business does not change its architecture to buy the product. The product conforms to the technology of the business.

Commerce Router

The disclosed architecture has a router. The route takes on the lowest level of the route. The system can know the route it took to get to the user or system. The system can take the route information as the message is being sent. The system knows the user who sent the message. The system knows the application that sent the information. It is 100% traceable. There is a type of message for each type of transaction. The message can go into any system. There are two types of routers. First type is the router that handles the messages. The first type has the channel, the warehouse, and other components like tracking entity controller. The change in the commerce router does not change the disclosed architecture because it is re-configurable. The second is the router that routes the message. The router or satellite sends back a message to the source warehouse. The change in the commerce router does not change the disclosed architecture because it is re-configurable.

Commerce Channel

The commerce channel is how information is transferred. The product can run without the channel. The change in the commerce channel does not change the disclosed architecture because it is re-configurable.

Commerce Warehouse

The commerce warehouse is how information is stored, calculated and configured. The product can run without the warehouse. A change in the commerce warehouse does not change the disclosed architecture because it is re-configurable.

Commerce Document Server

There are two ways to store a document. One is on the business site and the other is on a central site. There is a table of contents that link the document to the table of contents. The table of contents is the tracking entity. The search engine stores the information necessary to do word searches. The document is placed in a certain place and then scanned. The link uses the CP address to know the location. There are one or multiple CP addresses to do the search. The topic search CP address and the document link. The document can be stored on the image server or on any other server. An image server is like, for example, a Fuji Medical Inage Box. The link structure is a DNA class string. The change in the document server does not change the disclosed architecture because it is re-configurable. The tracking entity table is re-configurable; the search engine is re-configurable; CP address is re-configurable; and classification is re-configurable. The document has content place, the content person, the content text, the subject, the author, and other information.

Commerce GUI

There is the phone book structure. This structure allows all business to sell a service or product without having the presentation of a shopping cart through the phone book concept. The system allows for categories. The system uses a tracking entity. The server can be divided to help with the server load. The change in the commerce GUI does not change the disclosed architecture because it is re-configurable.

Commerce Search Engine

The search engine comes from the hierarchy. The account, the item and many more are some of the hierarchies. There is a category tag IHCP. There is information type, DNA string for the topic, the level of the DNA string, and CP address to link to the subject. The change in the commerce search engine does not change the disclosed architecture because it is re-configurable. The disclosed architecture can be divided the search engine into multiple search engines.

Commerce Translator

The commerce translator can be a part of the product or can stand on it own. It converts messages. The change in the commerce translator does not change the disclosed architecture because it is re-configurable. It sends the information back to the source to let the source know it was converted. The system knows all the conversion.

Commerce Converter

The commerce converter is a part of the product. The system stores other numbers for the same item. The change in the commerce search engine does not change the disclosed architecture because it is re-configurable. It sends the information back to the source to let the source know it was converted.

Commerce Generators

The different generators create the connection of the two integration ends, create CP address both in numbers and in text; create the transaction entry screens, release screens and other screens; create messages; and create other information. The change in the commerce generator does not change the disclosed architecture because it is re-configurable. This system can generate any type of module.

Commerce Tracking Entity

The commerce tracking entity is the directory of all tracking entities. It controls all the tracking entities divisions. The change in the commerce tracking entity does not change the disclosed architecture because it is re-configurable.

Other Comments

The data can be stored anywhere. The system knows who has data ownership. The data is a distributed system. The business has control in knowing has their data. It does not have to be controlled by one exchange or web site. The system disperses information where the business releases their information. An example is that the pricing data does not have to be released to anyone, but it can be just read only. The open system allows the structures to be placed anywhere. This system places components anywhere. An example is the tracking entity can be placed anywhere.

Commerce Process

Processes

The Business Process Commerce Protocol is the business process of each company. This system allows for the business process to be modified. This makes an open system. The Workflow Process Commerce Protocol is how the system translates the message. The messages have steps. The Accounting Process Commerce Protocol is the new way of looking at accounting. The Structure Message Commerce Protocol is how a message is transferred. The part of the message has items that are defined and other that are open. The Commerce Nomenclature Commerce Protocol is how the messages can come into the system. This is the open interface and open language used to communicate.

Structures

The hierarchical structure can be created as the structure changes or is analyzed different. New structures can be created. The structure defines the search engines. As the business processes are defined the hierarchical structure is defined. It also will add new information to the tracking entity. The structure concept is how information is processed. The structures defined are transaction, account, items, directory, documents, search engine, tax and accounting, translation, conversion, and routing. There are many more structures. The structures can change because this is an open system and change will happen in an open system. The components are parts of the hierarchy.

Transport

The transport of all information is source and destination of each message. The messages can have multiple sources and destinations.

Commerce Source

There are permanent source IDs. There are many of the items that can have the DNA class string. The corporate ID is the hierarchy used to give each entity the ability to review his information. The entity information can be stored anywhere. These are some of the hierarchical structures. The world has to have a uniform structure to know where information is stored. Each industry has its own source cards. Each device has its own source card.

Commerce Messages

There are many types of messages. In an open system, new messages can be created. The disclosed architecture explains some types of the messages.

Commerce Process

The structure lends to easier mergers. The process can be modified. This is an open system. The merger can push information into the new system. There is a process to source card and destination card. If the corporations and governments place additional regulations, it does not change the disclosed architecture. The concept is the source and destination card. The scan card speeds up the entry process. The load process is where the server and the how the information is load. This is an open system. The structure lends to easy modifications.

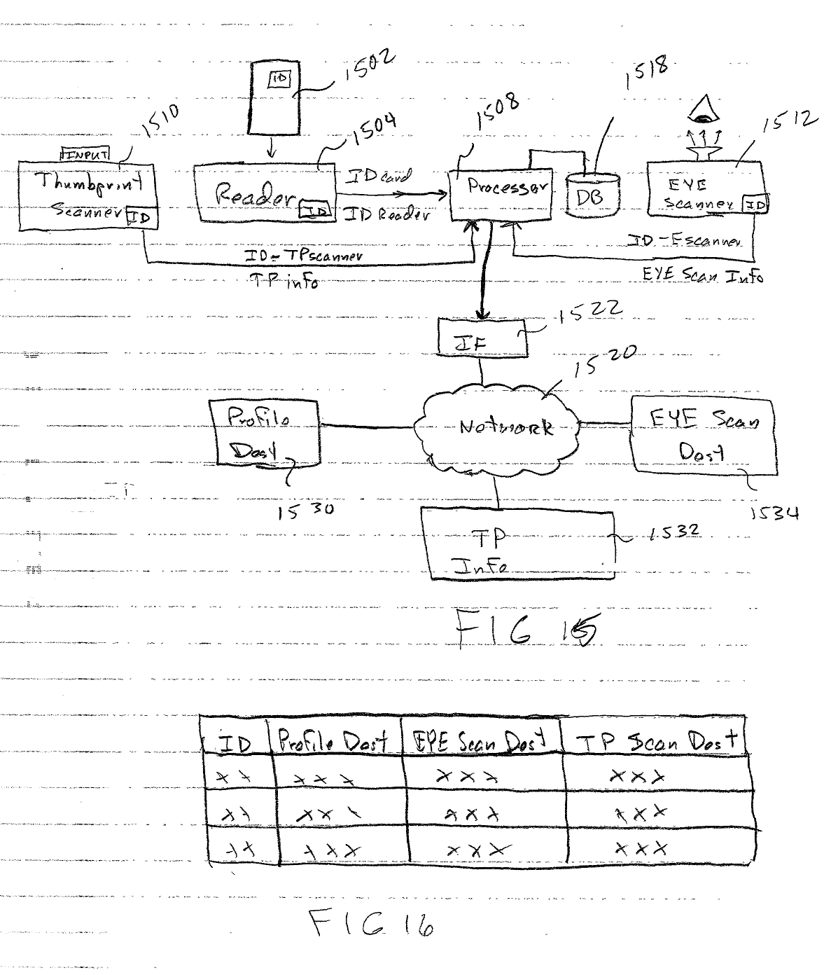

Referring now to FIG. 15, there is illustrated a diagram of an example of a commerce process. In this commerce process, there is provided a portable source card 1502. This source card 1502 is operable to be encoded with information such as, in the simplest form, an ID that uniquely identifies this card, which ID is uniquely associated with an individual. There might be an actual ID associated with the card as a device and an ID associated with the individual. In this process, this is a one way process which requires only extraction of the ID of the individual, i.e., that uniquely identifying this individual.

The card 1502 is operable to be inserted with a reader 1504 or interface therewith. The card 1502 could contain information in a microchip, i.e., a smart card, in a magnetic strip or in an optical configuration on the surface of the card. The reader 1504 could interface with the card 1502 via a magnetic reader, a wireless connection or an optical connection, or whatever is appropriate. The reader 1504 has a device ID associated therewith and is operable to extract the appropriate ID information from the card 1502. This is transferred to a processor 1508 to process the information. In addition, the user is also required to interface with different security devices. One security device could be a thumbprint scanner 1510 or an eye scanner 1512. Each of the thumbprint scanner 1510 and the eye scanner 1512 have device IDs associated therewith. The thumbprint scanner 1510 is operable to extract the thumbprint information, digitize this information and then transfer it to the process 1508 along with its associated thumbprint scanner ID and the information. Similarly, the reader 1504 is operable to transfer the extracted information from the card 1502 over to the process 1508 along with the reader 1504. The eye scanner 1512, in a similar manner, is operable to extract optical information about the eye, i.e., a scan of the retina, digitize this information and forward it to the process 1508 along with the ID of the eye scanner. The process 1508 has associated therewith a database 1518 and is operable to initiate certain programs to process all of the information. The ID associated with the card 1502 is operable to determine the destination on a network 1520 of the information for process in order to retrieve information. The card 1502 only has associated therewith an ID. This ID must be compared with some information stored in a database in order to determine if the user is a verified user. The network 1520 is interfaced through a network interface card 1522, a conventional interface.

In operation, the process 1508 has associated therewith in the database 1518 various information regarding the ID. The ID 1502, when initially set up in the system, has associated therewith destination information for thumbprint information and eye scanner information and even profile information for the purpose of verifying the ID. In this operation, the system must retrieve thumbprint information from some database and compare it with that of the thumbprint scanner 1510. This requires the location of that information. This is facilitated with some database structure in the database 1518 that provides a relationship between the ID of the card 1502, i.e., the unique ID associated with the individual possessing the card, and defining the location of the corresponding thumbprint information of the user which was recorded when the card was issued. This therefore constitutes the destination information. The process 1508 will then utilize the ID to determine where on the network 1520 this information exists. In the embodiment illustrated in FIG. 15, there is provided a first destination 1530 for the profile information regarding a user, a second destination 1532 associated with thumbprint information and a third destination 1534 associated with eye scanned information. The destination information defines where on the network that particular unique ID of the individual has an associated type of information disposed. As such, there may be many locations where profile information is stored with the ID having an association with only destination information to the profile information for that ID. Therefore, the process 1508 does not have a predetermined knowledge of where the information is, but, rather, it requires the ID and its relationship to determine the relationship.

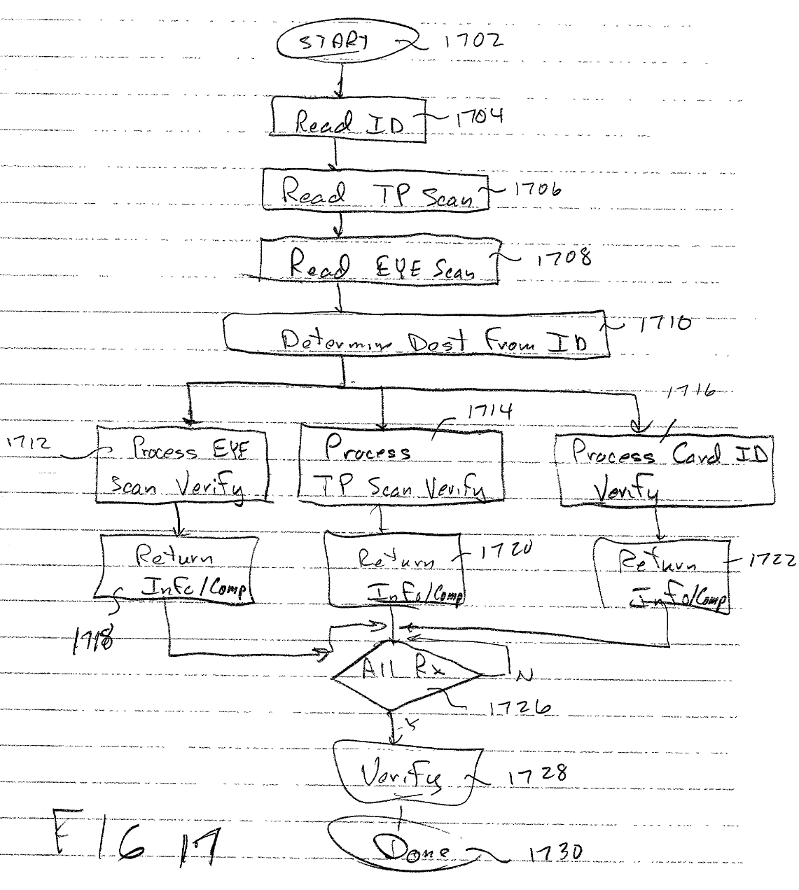

Referring now to FIG. 16, there is illustrated a table illustrating the relationship between IDs and the various destinations. This is typically downloaded to the database 1518, or it can be disposed on a separate node on the network. The process running in the processor 1508 requires that there be some type of relational database to determine this information merely from the ID. Once destinations are determined, then separate processes can be run for each verification operation, and these operated in parallel.

Referring now to FIG. 17, there is illustrated a flow chart depicting the process running in the processor 1508. The program is initiated at a start block 1702 and then proceeds to a function block 1704 to read the ID information and then to a function block 1706 to read the thumbprint information and then to a function block 1708 to read the eye scan information. It may be that the card must first be read and verified in order to utilize the thumbprint scan or the eye scan, or, alternatively, the order of reading is unimportant.

Once all of the information is extracted, then destination information of the comparative information must be determined, as indicated by function block 1710. Once the destination information is determined, then multiple processes can be run. The first process in block 1710 is associated with processing the eye scan verification operation. A second process operating in a block 1714 processes the verification operation for the thumbprint scanner information and the third block 1716 is operable to process the verification operation for the card ID, i.e., the individual. Each of these operations requires information to be retrieved from the appropriate destination, and then returned, as indicated by function block 1718, 1720 and 1722, respectively, for each of the blocks 1712-1716. The blocks 1718-1722 provide an operation wherein the returned information is compared with a measured information, with the ID of the card compared with a valid database. If the comparison is true, then a decision block 1726 will determine if all verifications have been received from each of the blocks 1718-1722. If all have been received and indicated as being verifiable information, then the program will flow to a function block 1728 to verify all three scanners and then to a Done block 1730. The verify block 1728 could be a light that turns on at each of the thumbprint scanner 1510, the card reader 1504 and the eye scanner 1512, independent of each other. When all three lights are turned on, this is a verification. Alternatively, this could be an OR function wherein all three verifications go to a central location that requires that they all be verifiable in order to generate one verification signal.

Commerce Products

They are products that are needed for the success of the disclosed architecture. This is an open system and it will create new products.

Commerce Implementation

Here are some departures from the disclosed architecture. It is to be understood that the above-described arrangements are only illustrative of the application. Those skilled in the art without departing from the spirit and scope of the present disclosed architecture may devise numerous modification and alternative arrangements. It should be recognized that for many of the elements the system multiple could be used (e.g. there can be 1-N source systems).

Source and Destination Tags

The source and destination creations can be incorporated in device readers on or in front of all devices. This disclosed architecture covers all devices that use the source and destination cards, which are a part of this disclosed architecture. Modifying a device does not allow the device to take the source and destination concept. The source and destination tags can be changed. The modification of the appearance of the card and of the information on the card can change the disclosed architecture. This disclosed architecture covers these changes. Governments and other corporations can change the source and destination cards to meet their standards. The card has levels of security, for example, the individual source card has higher security than other cards. It is your ID.

Classification and Structure

The classification of permanent IDs could be stored in other databases. The disclosed architecture owns the permanent IDs. The disclosed architecture also owns the corporate structure, the directory structure, the tracking entity structures, the world structure, the accounting structure, tax structure, and the phone structure. Other corporation can adapt these disclosed architectures into their applications. The disclosed architecture owns the logistics string. The disclosed architecture also owns the speed codes to be passed the call center menus. All call centers can adapt this part of the disclosed architecture into their applications. The disclosed architecture owns the DNA class strings. The DNA string is <string1><separatorA><string2>. The string1 <stringa><separatorb><stringb>. Other disclosed architectures can use the permanent ID concept and take part of the permanent ID. The CP address could be adapted to any disclosed architecture. This disclosed architecture creates CP addresses for everyone. The IP address is fixed for the growth of the computer industry. There are multiple concepts about classification and structures in the disclosed architecture that can be incorporated in other systems.

Incorporating Part of the Disclosed Architecture

The disclosed architecture offers is a total solution. All of this disclosed architecture can be incorporated in other similar architectures, such as software, devices, databases, structures, classifications, and other parts. Portions of the disclosed architecture can be pulled out and used in other products, e.g., Oracle Financials. They could incorporate the channel, the document controller, the warehouse, the search engine, the translator, the converter, the document server, the interchangeable security, the GUI, the classification, and other parts of the disclosed architecture. The messages system could be incorporated in the products like the router messages. The open and close message could be incorporated in browsers, in phone conversions, and other open conversions.

Front Disclosed Architecture

The information is being produced as the system collects data up front. The information could be gather from the back end. An example is that the documentation controller could be processed after and in between the process. The data could be collected from the transaction to create a matrix of the documents. Other systems could consolidate by sending the information to a collection pool to be consolidated and taking the results out.

Re-configurable system

Since this is a re-configurable system, the disclosed embodiments are not exhaustive. There are different data flows, different channels, different combinations, different hierarchies, transaction entry, and other various combinations which can be implemented. The administrator can re-configured on the fly.

Although the preferred embodiment has been described in detail, it should be understood that various changes, substitutions and alterations can be made therein without departing from the spirit and scope of the disclosed architecture as defined by the appended claims.

What is claimed is:

1. A commerce process, comprising the steps of:
reading a unique ID, which unique ID is associated with a plurality of information destinations on a network;
receiving at least two other external items of information in conjunction with the step of reading the unique ID, wherein the unique ID is associated with corresponding items of information that may be identical or similar to the received at least two other external items of information which corresponding items of information are disposed at predetermined destinations on the network;
a relational database having stored therein the relationship between the unique ID and the plurality of associated destinations on the network;
processing the read unique ID in response to the step of reading to determine the destination on the network for the corresponding information to the received at least two other external items of information;
interfacing with each of the destinations and performing a predetermined process utilizing each of the received at least two other external information items with the associated destination in an independent and separate operation in accordance with the predetermined goal.

2. The method of claim 1, wherein the predetermined goal is a verification process wherein a comparison step is performed between the received at least two other external items of information and the stored information to determine if they are identical.

3. The process of claim 1, wherein the unique ID is associated with an individual.

4. The process of claim 3, wherein the at least two other external items of information are associated with the proximity of the individual to a device that is utilized in the receiving step.

5. The process of claim 4, wherein the at least two other external items of information can comprise for at least one thereof, physical information about the individual.

6. The process of claim 1 wherein the relational database is disposed at the location wherein the step of reading is performed.
